(19) United States
(12) Patent Application Publication
(10) Pub. No.: US 2023/0217063 A1
(43) Pub. Date: Jul. 6, 2023

(54) EXTENDED DIGITAL INTERFACE (XDI) SYSTEMS, DEVICES, CONNECTORS, AND METHODS

(71) Applicants: Xiaozheng Lu, Dallas, TX (US); Jirong Gu, Irvine, CA (US)

(72) Inventors: Xiaozheng Lu, Dallas, TX (US); Jirong Gu, Irvine, CA (US)

(21) Appl. No.: 18/120,410

(22) Filed: Mar. 12, 2023

Related U.S. Application Data
(63) Continuation-in-part of application No. 16/762,438, filed on May 7, 2020, now abandoned.

(51) Int. Cl. H04N 21/434; G06T 7/521; H04N 21/442; H04N 21/81

(52) U.S. Cl. CPC H04N 21/4341; G06T 7/521; H04N 21/44209; H04N 21/816; H04N 21/6125

(57) ABSTRACT

Extended Digital Interface (XDI) provides systems, devices, connectors, signals, and methods to send 3D Vector and Motion based audio video serial digital signals through local systems or internet with significantly reduced bandwidth requirements and lower device costs, over longer cable runs. The XDI system has higher flexibility for connection topologies and scalability. The XDI system is much simpler to install employing the single coax cables and connectors, or internet, or Wi-Fi, which is simple and easy to work with, without introducing any signal quality losses or delays comparing to the current 2D Frame and Pixel based digital systems using multiple conductors like HDMI, DVI, DP or SDI when using the already compressed audio video content. The XDI system also provides solutions for integrating the uncompressed audio video content and Internet content into this system. These systems, devices, connectors and methods are collectively called “XDI” (Extended Digital Interface).

### CROSS-REFERENCE TO RELATED APPLICATIONS

This application claims the priority of U.S. patent application Ser. No. 16/762,438 of May 7, 2020, which claims priority to PCT/US18/59693 of Nov. 7, 2018, which claims priority to U.S. provisional application 62/583,867 of Nov. 9, 2017.

### FIELD OF THE INVENTION

The invention relates to a new Extended Digital Interface (XDI) audio video standard that uses Vector and Motion based video data in serial digital format that can transmit 4k, 8k video (and horizontal resolutions beyond 8k) signals over very long distances using low-cost coaxial copper cables, category (Cat) cables, internet, wireless transmissions etc., and electronic devices configured with circuitry for the Vector and Motion based video data with very low bandwidth requirements for much lower costs and increased reliability, as well as providing for flexible system topologies (star or daisy chain, or mixtures thereof). This new standard and its associated electronic devices will provide better audio video qualities as the current uncompressed standards like HDMI (High-Definition Multimedia Interface), DVI (Digital Visual Interface), DP (DisplayPort) and SDI (Serial Digital Interface) yet with a much lower bandwidth requirement. This XDI standard includes hardware and software innovations in systems, devices and components.

### BRIEF DESCRIPTION OF THE DRAWINGS

FIG. 1 schematically shows a prior art Frame and Pixel based video system with MPEG-2 compression.

FIG. 2 schematically shows an example embodiment of the current invention XDI Vector and Motion based video system's 3D image capture by 2 cameras.

FIG. 3A schematically shows an example embodiment of the current invention XDI Vector and Motion based video system's video acquiring by 3D cameras in moving human content.

FIG. 3B schematically shows an example embodiment of the current invention XDI Vector and Motion based video system's video acquiring by 3D cameras in moving cars content.

FIG. 4 schematically shows an example embodiment of the current invention XDI Vector and Motion based video system's computer language used in describing the objects' shapes and movements.

FIG. 5 schematically shows an example embodiment of the current invention XDI Vector and Motion based video system's video reproduction by 3D video projectors.

FIG. 6 schematically shows an example illustration of a video audio system representing prior art uncompressed digital formats like HDMI, DVI, DP or SDI.

FIG. 7 schematically shows an example illustration of a video audio system representing prior art uncompressed digital formats like HDMI, DVI, DP or SDI.

FIG. 8 schematically shows an example illustration of a video audio system with an embodiment of the current invention for the XDI system with Vector and Motion based video serial digital signals in a star topology.

FIG. 9 schematically shows an example illustration of a video audio system with an embodiment of the current invention for the XDI system with Vector and Motion based video serial digital signals in a daisy chain topology.

FIG. 10A schematically shows an example illustration of the front panel (top) and rear panel (bottom) of an embodiment of the current invention for a XDI Internet Streaming STB (Set Top Box).

FIG. 10B schematically shows an example illustration of a circuit block diagram of an embodiment of the current invention for a XDI Internet Streaming STB.

FIG. 11A schematically shows an example illustration of the front panel (top) and rear panel (bottom) of an embodiment of the current invention for a XDI Cable TV STB.

FIG. 11B schematically shows an example illustration of a circuit block diagram of an embodiment of the current invention for a XDI Cable TV STB.

FIG. 12A schematically shows an example illustration of the front panel (top) and rear panel (bottom) of an embodiment of the current invention for a XDI Satellite TV STB.

FIG. 12B schematically shows an example illustration of a circuit block diagram of an embodiment of the current invention for a XDI Satellite TV STB.

FIG. 13A schematically shows an example illustration of the front panel (top) and rear panel (bottom) of an embodiment of the current invention for a XDI 8k Blu-ray Player.

FIG. 13B schematically shows an example illustration of a circuit block diagram of an embodiment of the current invention for a XDI 8k Blu-ray Player.

FIG. 14A schematically shows an example illustration of the front panel (top) and rear panel (bottom) of a current invention XDI Hard Drive Player/Recorder.

FIG. 14B schematically shows an example illustration of a circuit block diagram of an embodiment of the current invention for a XDI Hard Drive Player/Recorder.

FIG. 15A schematically shows an example illustration of the front panel (top) and rear panel (bottom) of an embodiment of the current invention for a XDI Compression Encoder/3×1 Switcher.

FIG. 15B schematically shows an example illustration of a circuit block diagram of an embodiment of the current invention for a XDI Compression Encoder/3×1 Switcher.

FIG. 16A schematically shows an example illustration of the front panel (top) and rear panel (bottom) of an embodiment of the current invention for a XDI Compression Decoder/1×3 Splitter.

FIG. 16B schematically shows an example illustration of a circuit block diagram of an embodiment of the current invention for a XDI Compression Decoder/1×3 Splitter.

FIG. 17A schematically shows an example illustration of the front panel (top) and rear panel (bottom) of an embodiment of the current invention for a XDI 4×4 Node (32×32 Matrix Switcher).

FIG. 17B schematically shows an example illustration of a circuit block diagram of an embodiment of the current invention for a XDI 4×4 Node (32×32 Matrix Switcher).

FIG. 18A schematically shows an example illustration of the rear panel of an embodiment of the current invention for a XDI display (TV or projector) I/O (Input/Output) portion.

FIG. 18B schematically shows an example illustration of a circuit block diagram of an embodiment of the current invention for a XDI display (TV or projector) I/O (Input/Output) portion.

FIGS. 19A and 19B schematically shows an example illustration of a software flowchart of an embodiment of the current invention for Link Bandwidth Management.

FIGS. 20A and 20B schematically shows an example illustration of a software flowchart of an embodiment of the current invention for Dynamic Vector and Motion Based Video Compression.

FIG. 21A schematically shows an example illustration of two removable sleeves, one connector core and one female jack of an embodiment of the current invention for Micro Coaxial Cable Connectors.

FIG. 21B schematically shows an example illustration of alternative Micro Coaxial Cable male and female Connectors where the male connector rear flange is inserted into the coax wire by pushing and crimping or by screwing into the coaxial wire, and the front probe is locked in place into the female connector by raised lips on male connector and a matching groove in female connector.

### BACKGROUND

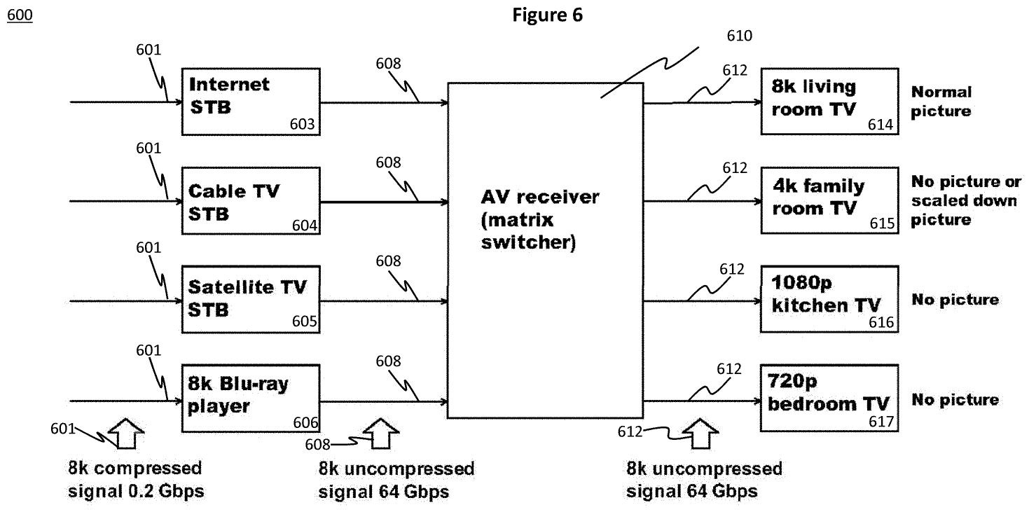

Current popular digital audio video standards of HDMI, DVI, DP and SDI all use 2D Frame and Pixel based uncompressed signals. The advantage of using uncompressed signals is that there is no signal quality loss. However, with the rapid increasing demand and use of higher video resolution video, year after year, these uncompressed standards are increasingly not able to handle the super high data rates demanded for increased video resolution (an uncompressed 8k 60 Hz 4:4:4 signal data rate is 64 Gbps). Further, here are limitations for such prior art systems:
1) Cable length limitations: at 64 Gbps, the longest usable length of a copper cable is less than 2 meters. Even the shortest connections may require the much more expensive fiber cables which is often prohibitive commercially. See FIG. 6.
2) High device bandwidth requirement and costs: at 64 Gbps, the Integrated Circuit (IC) chips needed to make the devices useable become very expensive, and the Printed Circuit Board (PCB) layout design becomes very difficult (See FIG. 6).

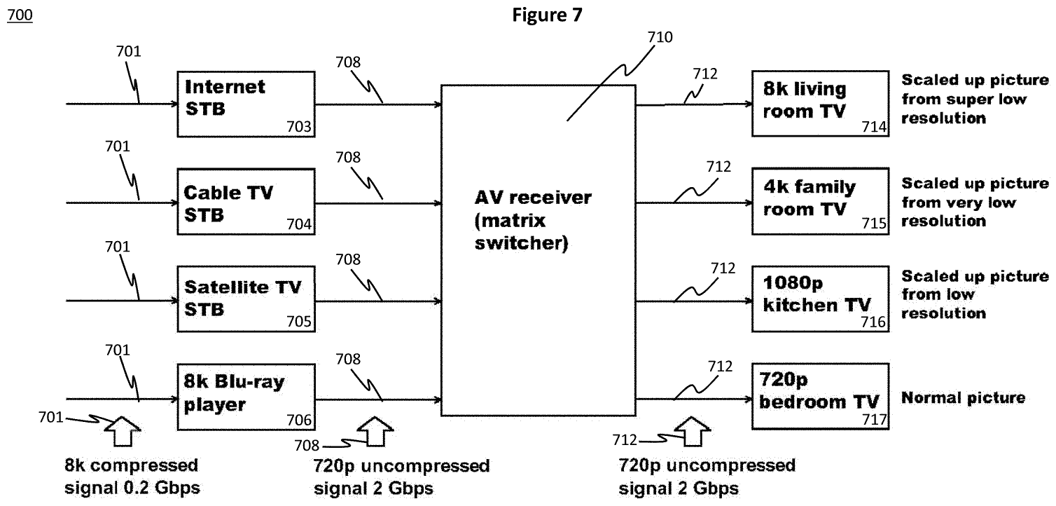

In addition to bandwidth related issues, the current standards also have other challenges:
3) System reliability and compatibility problems: higher the signal data rate, shorter the usable cable length. If the signal data rate sent from a HDMI, DVI, DP or SDI device exceeds the maximum bandwidth of that physical link (cable), the downstream sink won't get any signal, and the system breaks down. (FIG. 6 and FIG. 7)
4) No clean solution for mixed display resolutions: the video signals are pixel based with fixed resolution, and such a prior art system can only send one resolution at a time. When a system has several displays with different native resolutions, the system must choose one resolution. If the system chooses the highest resolution among displays as the signal resolution, then the other displays with lower resolutions would either get a scaled down picture or no picture (FIG. 6). If the system chooses the lowest resolution among the displays as the signal resolution, then the higher resolution displays would show the pictures scaled from much lower resolution (FIG. 7).
5) Lack of field termination and connector locking: HDMI, DVI and DP have multiple conductors inside the cable which makes field termination with connectors difficult. HDMI does not have locking features in the connector, making it unreliable for critical applications.
6) Star topology and difficulty of installation: all these standards use star topology, in which all source devices and displays are connected to a central switching device. This star topology often requires long cable runs, and a bundle of cables to go down from the conference table to underground and inside the wall. Also, because any given model of matrix switcher has a fixed number of inputs and outputs, manufacturers have to make over a thousand different switcher models with different input and output numbers and formats to fit all needs.
7) Many conductors in a cable: HDMI, DVI and DP are semi parallel digital systems, having 19, 18 and 20 conductors (wires) respectively. This makes the connector termination more difficult as discussed in point 4 above, and also the cable construction, circuit and PCB design more difficult.
8) Extra compression hardware and license costs: currently, almost all TVs and projectors have built-in compression decoder circuits, and license fees are required for these technologies. However, in an uncompressed signal HDMI, DVI, DP or SDI system, these built-in compression decoder circuits are not used. The uncompressing is done in the built-in compression decoder circuit inside the source devices, incurring an extra set of hardware and license costs.
9) Not Internet friendly: because the audio video contents sent through the Internet are compressed, the local HDMI, DVI, DP or SDI signals are uncompressed, the data rate of the latter is hundreds of times bigger than the data rate of former, so there's no easy way to send local HDMI, DP or SDI through the Internet unless the very expensive compression encoders used.
10) Not natively 3D: the current HDMI, DVI, DP or SDI are all naively 2D signals. It needs at least 2 cameras in different locations pointing to the same scene to capture the 3D images, and more signal channels and bandwidth to transmit the 3D videos.

In HDMI, DVI, DP or SDI systems, the source devices (Internet Streaming STB, Cable TV STB, Satellite TV STB, Blu-ray Player, Hard Drive Player/Recorder, etc.) first un-compress the signals, then send the high data rate signals through the local systems to the displays. However, most of the source audio video content from the Internet, Cable TV, Satellite TV, Discs, and Hard Drives are all compressed content. Decompressing the audio video signals in the source devices or in the displays makes no difference in the signal quality and delay. In this case, the compressed signal in local systems does not have any disadvantages because the original content is also already compressed. However, because the data rate of a compressed audio video is many hundred times smaller than an uncompressed signal, the bandwidth requirements for a compressed signal in a local system is reduced by hundreds of times.

### SUMMARY

Unlike the prior art video that uses the Frames and Pixels to describe the video content, embodiments of the current invention of the Extended Digital Interface (XDI) standard. The XDI format video is 3D geometrical modeling of live capture or computer-generated animation functions much like the human visual system. Embodiments of XDI systems comprise 3 main types of devices: 1) XDI video acquiring devices; 2) XDI video distribution devices; 3) XDI video display devices. The video signals in the XDI systems are serial data with Vector and Motion based data or primarily Vector and Motion data, and not traditional Frame and Pixel based data.

XDI Video Acquiring

A serial digital system, methods, and software for Vector and Motion based video signals for XDI are provided in numerous embodiments. The serial digital systems comprise of at least one XDI source device and one XDI display device connected by at least one coaxial cable. The original video content is in a Vector and Motion based compressed format. The system transmits the XDI Vector and Motion based video signal in a serial digital format. This XDI Vector and Motion based video signal is decoded by the display device's built-in video decoder before being shown on the screen.

The XDI Encoder analyzes the video information from a camera or other video source, recognizes the objects in the scene, builds 3D models or Vectors to describe each object, and also records the 3D models' movements like positioning movement direction and speed, rotation movement direction and speed, and use the resulting binary codes to record or send these 3D models or Vector and Motion or their movements in video systems. This video signal is called the XDI Vector and Motion based video signal.

By analogy the eye an XDI camera or video processor device acquires life images which are modeled in 3D in the human brain (or XDI serial line CPU/GPU or video processor) for storage in memory as complete images. An XDI video processor has circuitry and software to capture and recreate objects as 3D or 2D Vector, Motion, and Surface Texture compositions. Depending on the resolution required for display the 2D and 3D modeling capacity of video processors and associated circuitry can be scaled accordingly to capture live video images. Embodiments can also convert prior art Frame and Pixel video to Vector, Motion, and Surface Texture compositions. For example, if there's a person standing in a classroom in front of a whiteboard making presentation, the XDI signal would use geometry parameters to describe the front wall of the classroom as how many meters wide and how many meters tall; what color and texture; distance off the view center; and tilt angles among other parameters. Then it would describe the white board as how many meters wide and how many meters tall; what color and texture; distance off the view center; and tilt angles among other parameters. Then it would describe the presenter's head as an ellipsoid of how many centimeters tall, wide, deep; how many meters off the view center, tile angles; color and texture. Then the 2 arms as two sections of cylinders with how many centimeters long, radius, tile angles, and joint points with body, between arm sections and with hand, and color and texture etc. Then the movements of each object will be described for example the direction of movement in the relationship to a 3D (x, y, z) axis, the moving speed measured in meters per second m/s; and the rotation of speed as revolutions per minute (RPM) will all be described in. Examples of 3D mathematical modeling include but are not limited to Wireframe modeling, Surface modeling, Solid modeling, Polygonal modeling, NURBS (Non-Uniform Rational B-splines), CAD (Computer-Aided Design), Digital Sculpting, Scan-based modeling, Photogrammetry, etc. (https://3d-ace.com/blog/types-of-3d-modeling-choosing-the-right-one/). Two important elements of the XDI format for XDI video are Vectors and Motion for 3D modeling of data from a central processing unit (CPU) containing all the circuitry and software needed to process input, store data, and output results data that is output as serial data or covered from parallel data to serial data for transmission. Embodiment XDI circuitry requires video input lines in series or parallel, video memory, video processing circuits, video output lines in series or parallel format. Embodiment of XDI software requires the algorisms to recognize the 3D figures from the incoming video using one or more of the 3D modeling listed earlier in this paragraph, or equivalents, to describe each 3D figure in the shape, size, texture, color, position, orientation, movements, etc. in binary code, and form the data into serial data in standard IP packets.

In an XDI system the 3D models for each object, the front wall, the white board, the human head, the arms and legs in the example here, are the Vectors. For example, the formulae to describe a 3D straight line is (x−x₀)/a=(y−y₀)/b=(z−z₀)/c where the (x₀, y₀, z₀) is the coordinate where the line passes, and the (a, b, c) is the direction of the 3D line; and the formulae to describe a 3D ball is (x−h)²+(y−k)²+(z−l)²=r² where the bM's center is at “h, k, l” and its radius is “r”, The 3D movements for each object are called Motions. Surface texture is a third element needed to describe the objects more realistically.

Surface texture is needed when the surface of an object is too rough or otherwise altered from a smooth surface to be described as an even surface, like matte finished table. Surface texture can be 3D modeled but requires scaling of computational power to achieve high resolution. In some alternate embodiments, if the number of recognizable tiny objects in a surface area exceeds the given computing power of the video processor in a display device, for example features such as a human face with a beard, the video processor can also use the transitional Frame and Pixel based video signal to get information of the details on a given surface, and send a small sample section of Frame and Pixel based data together with XDI 3D geometry descriptions of the section width, height, from which surface area of a larger recognized object; and the relative area info of this section to the total surface area of that object. The video processor in the display end would use the required XDI Vector and Motion data to reconstruct the 3D geometry models of each object, and the movements of each object, if necessary, fill in the object surface with the Surface Texture data from the Frame and Pixel based video content from the sample section of that surface area. In some hybrid embodiments for existing devices the 32- or 64-bit parallel video data needs to be converted to the 1-bit serial video date in XDI format. In pure XDI systems the video data is captured as 3D modeled Vector and Motion data as serial video data.

There are 3 main ways to acquire an XDI video signal:

1) Live video capture from real objects: using at least 2 video cameras mounted in two adjacent locations with a fixed arm in between, pointing to the same view with slightly different viewing angles are required in this video acquiring process. A video processor would compare the objects in view one by one from the two cameras, just like the brain compares the objects in view one by one from each of the two eyes. With the slightly different images from the two video or more cameras, the video processor would recognize the 3D objects in the view and each object's geometrical parameters described in paragraph [0041], then the video processor would generate the XDI Vector and Motion serial data. If needed, the video processor would also capture the Surface Texture data for each surface of each object. For the objects with complex Surface Textures, in some embodiments the video processor can choose to create many vector formulars one for each fine feature such as a bump of the texture, or otherwise, or in other embodiments the video processor can choose one small area of that Surface and take a snapshot of it as a Pixel based still picture, then send this Pixel image data as Surface Texture data, to be used in display device's Video Processor to repeat this pixel based Surface Texture on all the surfaces with such material, while still reconstructing the object's 3D shape in Vector based data.

2) Converted from the prior art Frame and Pixel based video: an XDI video processor can convert the prior art Frame and Pixel based video data into the current XDI Vector and Motion based serial video data. In these embodiments the XDI video processor would receive and store multiple frames of data from a Frame and Pixel based video; then would compare the movement of pixels among the adjacent frames to recognize the objects in these frames, their geometrical parameters, like height, width, depth, directional facing or position, direction of movement, and speed, color, and if necessary, the Surface Texture, then write these geometrical parameters into serial data, which effectively converted the prior art Frame and Pixel based video into the current invention XDI Vector and Motion based video. Alternatively, the Surface Texture can be separated into thousands of little individual objects (bumps) and each encoded by its own 3D Vector data, which would require increased computational power. The input traditional Frame and Pixel based video data rate is determined by this formula:

D=Hp/rH×Vp/rV×Vf×Pd/rT

In which D is the total data rate; Hp is the visible horizontal pixel number; rH is the percentage of the H data used in the visible pixels; Vp is the visible vertical pixel number; rV is the percentage of the V data used in the visible pixels; Vf is the frame rate (frames per second); Pd is the pixel bit depth or how many bits for digital encoding per pixel; rT is the percentage of the data stream is used for video.

For example, a normal 4k 60 Hz digital video, in which the Hp=3840 pixels, rH=0.9, Vp=2160 pixels, rV=0.9, Vf=60 Hz, Pd=24 bits, rT=0.9, the total data rate is about 16 Gbps, and it's fixed no matter how simple or complex the video content is. It's highly redundant to send the same frames of pixels again and again when there's little or no changes from one frame to the other.

3) Computer generated animation videos: a computer has at least a CPU (central processing unit) and a GPU (graphical processing unit). The CPU would generate the 3D (or 2D) geometrical parameters, like in which section of the computer screen that would be a box, a circle, text, or other features, as well as their positions, sizes, movements and colors and other parameters. The GPU then turns these geometry parameters into the pixels on the computer screen. This is the same process in computer-based video games, in which the CPU would give the geometrical parameters of the cartoon figure's head shape, size, facing direction and movements or other parameter; and then the GPU converts these geometrical parameters into Frame and Pixel based video content on the computer display screen. The geometrical parameter descriptions in computer language from the CPU to GPU are in parallel data of mostly 64 bits. In XDI embodiments, an encoder that changes such parallel data into serial data and that formats it into standard IP packets, then this new serial data becomes the XDI video data.

The data rate of a serial Vector and Object base XDI depends on how many objects in the frame and how much do they move. The XDI video only send the descriptions of each object once, and their movements each time when that occurs. When no new object appears and no movements of the existing objects, the XDI video data rate can be zero. On average, the XDI video data rate is about 10,000 times smaller than a traditional Frame and Pixel based video for the same content!

XDI Video Distribution

Embodiment XDI video distribution devices including the data storage devices like standard [Add] hard drives or SSD based storage drives; embodiment signal switching devices like the switchers and matrix switchers; embodiment signal distribution devices like the splitters; embodiment signal transmission devices like the transmitters, receivers and network routers.

In other embodiments there can be additional XDI Vector and Motion based source devices, switching and distribution devices, streaming devices and display devices in the system connected by multiple coaxial, fiber optic cables, wireless or wired network connections with XDI Vector and Motion based video signals in serial digital format.

In other embodiments when uncompressed digital audio video signals need to be transmitted through this XDI Vector and Motion based video serial digital XDI system, there can be a XDI Encoder that recognizes the objects and their movements, and use the Vector and Frame data to describe the objects and their movements respectively (see the more detailed discussions in [0043]), then convert the video into the XDI Vector and Motion based video serial digital format, and/or XDI Decoder that converts Vector and Motion based video serial digital signals for parallel and decompresses signals to an uncompressed format, in the system. The hardware and software that converts the traditional Frame and Pixel based digital video into the XDI Vector and Motion based serial digital video in different variants represent multiple embodiments of this patent application being known by a skilled engineer.

In one embodiment the devices in a XDI system are connected in a Star topology where all source devices are connected directly to a central matrix switcher, and all display devices are connected directly to that central matrix switcher.

In other embodiment the devices in a XDI system are connected in a Daisy Chain topology where all devices are connected in a series without any central switcher.

In yet other embodiments the devices in a XDI system are connected in a mixture of Star and Daisy Chain topologies.

In some embodiments the XDI devices have the HDCP circuits and software when the content protection is required. HDCP circuits and software represent alternate embodiments where these are incorporated into the devices and methods as set forth in the figures and elsewhere in this specification.

All XDI devices comprise circuit boards with a MCU (Micro Control Unit) and its associated Memory to control all the local operations inside the device and to control all system wide operations with other connected devices.

All the XDI devices also comprise circuit boards with EQ (Equalizer) circuitry that amplifies and reshapes the signals and circuitry for a Bandwidth Manager that measures the physical link bandwidth and makes sure the signal data rate never exceeds the target bandwidth; circuitry for a PDX (Power over XDI) that provides the remote power capability over the same single coaxial cable; circuitry for a Compression Controller that works with the Bandwidth Manager to send or request the right amount of audio video content data that is requested by the displays and that will not exceed the physical link's maximum bandwidth.

All the XDI devices that support the Daisy Chain features further contain at least one XDI input and at least one XDI output. On the circuit board inside these devices, there are circuitry for an EQ and a Bandwidth Manager; a PDX; a TDM (Time Domain Multiplexing) de-Mux (de-Multiplexer) that converts one serial data stream with multiple sets of independent audio video signals into multiple serial data streams each with one set of independent audio video signals; circuitry for a Daisy Chain Processor (matrix switcher) that selects which upstream serial streams to bypass to the downstream devices and which one is replaced by local signal stream, or which upstream serial signal is extracted to local circuit to be converted and shown on connected local display; circuitry for a TDM Mux (Multiplexer) that combines multiple individual serial streams into one serial stream with multiple sets of independent audio video signals; and circuitry for another EQ and Bandwidth Manager.

In other embodiments the system can comprise an XDI Node device with at least one XDI input and at least one XDI output. The embodiment comprising multiple inputs and one output is called a switcher. The embodiment comprising one input and multiple outputs is called a splitter. The embodiment comprising multiple inputs and multiple outputs is called a matrix switcher. All these embodiments contain circuit board inside with circuitry for EQ, Bandwidth Manager, and several TDM de-Mux, after which all the independent audio video sets from all XDI inputs are separated into multiple serial data where each contains one set of audio video content. The signals are all fed into a matrix switcher to select which serial stream goes where. After the matrix switcher, several, TDM Mux, each combines several serial streams together into one serial stream with multiple sets of audio video content and feeds them into several EQ/Bandwidth Managers to be sent to downstream devices.

The software for the Link Bandwidth manager at the XDI input and output circuit of every device has the functions of measuring the link bandwidth and managing the signal data rate. At the system initial power up, new connection or by request, the Bandwidth Manager in the upstream device pings the Bandwidth Manager in the downstream device. If no response, the Bandwidth manager will mark no device downstream. If there's a response, it will start sending test signals starting from the lowest data rate of 10 Mbps, and see if the downstream device responds with a correct answer. If so, it will test at 100 Mbps, and repeats until no response or correct response. Then it will mark the previous data rate with correct response as passed, then repeat the test of the 2, 3, 4, 5, 6, 7, 8 and 9 times of that data rate, and find the last (maximum) data rate with the correct response. Then this data rate is recorded as the maximum bandwidth for this link and it is registered with all devices in the system. Once all the link maximum bandwidth is recorded, the Bandwidth Manager will process the signal data rate requests from all displays, compare it with the maximum bandwidth for all links in between, and decide if that data rate can pass through. If not, it will work with the Compression Manager circuits in the source devices to reduce the signal data rate. This process also manages the number of signal feeds through each link in the daisy chain enabled devices.

The Compression Manager in source devices manages the compression ratio based on the signal data rate requested by the displays, the allowed physical link maximum bandwidth in between, and the available source content qualities, and decide the signal data rate (compression ratio) to use for each device. The Compression Manager in embodiments is in the display devices and manages the decompression process to reconstruct the video content to match the native resolution of the screen, and the audio speaker arrangement.

XDI Video Displays

The XDI video display devices have 3 main types: 1) the “true” 3D image projectors that projects the 3D motion images in midair; 2) the “simulated” 3D image flat panel displays that generates 2 sets of images for the left and right eyes and the viewers would use 3D glasses to let each eye picking up the image for that eye; 3) the downgraded 2D image on flat panel displays or flat screens projected by projectors. All these embodiments display devices need the XDI serial data to parallel data converter to change the XDI's 1-bit serial data to the 32- or 64-bit parallel data; embodiments of the 2^{nd} and 3rd types of devices also need an XDI video processor described in details in paragraph [0043] to convert the Vector and Motion based video data into Frame and Pixel based video data, similar to a computer GPU's function.

XDI Connectors

Embodiments of the current invention also comprises a set of micro coaxial male and female connectors. The male connector fits the same RG179 coax cable as the prior art DIN 1.0/2.3 connector does, but with a much smaller connector height to fit the very thin profile of devices like the smartphone, tablet or other such devices. The male connector consists a connector core for electrical contacts, and a removable sleeve for mechanical locking. The connector core comprises 3 components, the center conductor pin from the coax wire for signal contact, the inner ring pushed in between the coax wire's inner insulation and braiding for ground contact, and the outer ring crimped over the coaxial wire's outer jacket for mechanical bonding. Embodiments include two types of removable sleeves, one with the round cylinder for locking into the female DIN 1.0/2.3 connector; the other with left and right hooks for locking into the current invention female micro coax connector. These two sleeves have common features: an open slot along the length of the sleeve for the coaxial wire to slide into. Once the coaxial wire sliding in from the side, the removable sleeves slide forward along the coaxial wire onto the connector core, and semi-locks in the detain position by the shallow groove around the connector core and the shallow bump ring along the inner side of the sleeves. In scenarios where there is an accidental pull, the removable sleeve is the first point to break to protect the expensive devices on the female side of the connection, and the coaxial wire and male connector core, and can be replaced easily at low cost.

Embodiments of the current invention further comprises an alternative set of micro coaxial male and female connectors where the male connector rear flange is inserted into the coax wire by pushing and crimping or by screwing into the coax wire, and the front probe is locked in place into the female connector by raised lips on male connector and a matching groove in female connector. In such embodiments for male connector and female connector for coaxial wires, the male connector has a cylinder shaped probe with an inner and outer surface with a front end and a rear end, where the front end the outer surface has a raised lips of the surface and the female connector has a cylinder shaped receptacle with an inner and outer surface with a front end and a rear end, where the rear end's inner surface has a groove cut through the surface and where the raised lips of the male connector fall into the groove of the female connector when the male connector is inserted fully to form a mechanical lock.

Additional preferred embodiments follow for the XDI digital video system. In one embodiment an XDI digital video acquisition, generation, transmission, and display system comprising: at least one video source device; each of the video source devices further comprising; at least one circuit board comprising one or more circuitry elements and software for acquiring, generating, modeling, and processing of 3D Vector and Motion video data as descriptions of a plurality of object's shape, position and movements, or for acquiring, generating, modeling, processing, and converting parallel Frame and Pixel video data into 3D Vector and Motion descriptions of a plurality of object's shape, position and movements as 3D serial video data for transmission, where the 3D Vector and Motion serial based video data are generated in one of the 3 ways: 1) live video capture from real 3D objects; 2) live video converted from Frame and Pixel based video data; and 3) animated video generated by computer CPU; a plurality of video transmission devices configured with circuitry for transmitting, receiving, switching, and converting 3D Vector and Motion based video serial data from one device to another using some or all of the following circuits and their software selected from the group consisting of an EQ (equalizer), a Bandwidth Manager, a TDM demux (time domain multiplexing demultiplexer), a daisy chain processor, a TDM mux (multiplexer), a PDX (power on XDI), a compression encoder, a compression decoder, a MCU (micro controller unit), and other transmission circuitry; at least one display device further comprising; at least one serial to parallel video data converter circuit that converts the 1-bit serial data to 32 or 64 bit or other bit width parallel video data for a graphic processing unit (GPU); each of the at least one display devices further comprising one or more GPU, where each of the at least one GPUs is configured with circuitry and software for receiving video data in a 3D Vector and Motion serial format and for converting it into the video data needed for one of the 3 or more ways of displaying the image; at least one cable, where the at least one cable is configured for transmitting 3D serial digital video data between video capture or generation devices, transmission devices, and display devices of the system; and software for acquiring, modeling, transmitting, and converting 3D serial digital video data from a first format to a second format or third format or more formats or combinations thereof.

In some embodiments, of the digital video system where the circuitry for video capture for a plurality of live or real 3D objects the system further comprises at least 2 image sensors placed offset by a distance at a first and a second angle pointing in a first and a second direction; and at least one Video Processor using least one Software application to compare the images captured by the at least 2 image sensors to recognize each of the 3D object in the view, and to generate a detailed description of each object's position, size, shape, orientation, movement, surface texture or other features; an optional separate video processing device comprising at least one video processor.

In other embodiments, of the digital video system where the circuitry for video capture devices for a plurality of live or real 3D objects the system further comprises a LiDAR (light detection and ranging) sensor to send laser beam to scan the field of view, capture the light bounded back from the objects and convert it into video data; and at least one Video Processor using least one Software application to read the video data from the LiDAR, to use the timing from the bounced back light from each objects to recognize the distance, depth and speed of each objects, using the angle of bounce back light from each object to recognize the size, orientation texture of each objects in the view, and to generate a detailed description of each object's position, size, shape, orientation, movement, surface texture or other features; an optional separate video processing device comprising at least one video processor.

In still other embodiments, of the digital video system, the system where the 2 image sensers and the video processor further comprises hardware and software that can choose one small area of that surface and take a snapshot of it as a pixel based still picture, then send this pixel image data as surface texture data, to be used in the display device's GPU to repeat this pixel-based surface texture on all the surfaces with such material, while still reconstructing the object's 3D shape in Vector and Motion based data.

In some embodiments, of the digital video system, the system where for the video converted from the prior art Frame and Pixel based video data, the circuitry further comprises a video processor where the video processor receives and stores multiple frames of data from a Frame and Pixel based video; and then compares the movement of pixels among the adjacent frames to recognize the objects in these frames, their geometrical parameters, like height, width, depth, directional facing or position, direction of movement, and speed, color, and if necessary, the Surface Texture, then writes these geometrical parameters into video data; and then feeds the video data into a Parallel to Serial converter circuit with its software to convert the 32 or 64 bit or other bit width parallel data into 1-bit serial data; and packetize the data for IP transmissions

In some other embodiments of the digital video system for computer generated animation videos, the video source device further comprises a central processing unit (CPU) IC chip and its associated surrounding circuits using 3D animation software selected from the group consisting of Microsoft PowerPoint, Autodesk Maya, Blender, SideFX Houdini, and equivalent software for generating the 2D and 3D data describing each object's position, size, shape, colors movements and other geometrical parameters. If the video signal from any of these video source devices or components are in a parallel data format, then at least one parallel to serial converter converts the 32 or 64 bit or other bit width video data into the 1-bit serial video data; at least one packetizing circuit and software that then converts the 1-bit serial data into packetized data fit for the IP based data transmission.

In many embodiments of the digital video system, the XDI Vector and Motion based serial data can be received from the group consisting of an internet stream STB (Set Top Box), a cable TV STB, a satellite STB from remote sources, a local disk player, and a hard drive player.

In added embodiments of the digital video system, the XDI Vector and Motion based serial data is switched by XDI switchers, matrix switchers or daisy chain systems or nodes, or splitters from different source devices to different sink devices.

In certain embodiments of the digital video system, the at least one device further comprises a circuit board with a Bandwidth Manager that tests the actual maximum bandwidth of each physical link in the system and gives the allowed signal data rate instructions to Compression Manager for maintaining the signal data rate never exceeding the link maximum bandwidth.

In other embodiments of the digital video system, the at least one device further comprises a circuit board with a Compression Manager that gives instructions to a Compression Encoder on the compression ratio to be used based on the allowed signal data instructions from the Bandwidth Manager to ensure the signal data rate never exceeding the link maximum bandwidth.

In some other embodiments of the digital video system, the at least one device further comprises a circuit board with a Power over XDI circuit that sends power through the same single coaxial cable linking the devices to allow remote powering capability.

In certain embodiments of the digital video system, the system further comprises: at least one daisy chain device; each daisy chain device further comprising; a TDM (Time Domain Multiplexing) demux (De-Multiplexer) circuit that converts one link of multiple sets of audio video data from upstream device into multiple links that each contains only one set of audio video data; a Daisy Chain Processor that is a matrix switcher circuit that chooses which upstream signals to bypass for this device to the downstream device, and which upstream signal is replaced by the local signal, and which upstream signal is extracted for local display; and a TDM mux (Multiplexer) circuit that converts multiple links that each contains only one set of audio video data to one link of multiple sets of audio video data to downstream device.

In some embodiments of the digital video system, the at least one Source Device further comprising: a Source Device, the Source Device further comprising circuitry that reads audio video data from a storage medium (e.g., disk or like device, hard drive, semiconductor memory) or from external sources like the Internet, Cable TV or Satellite TV and converts the signals to the compressed serial digital data.

In some other embodiments of the digital video system, the system further comprising: a Node (Matrix Switcher) device that has a circuit board with; one or more serial inputs that each carries at least one sets of audio video content; one or more TDM (Time Domain Multiplexing) demux (De-Multiplexer) circuit that each converts one link of multiple sets of audio video data from upstream device into multiple links that each contains only one set of audio video data; a matrix switcher circuit that chooses which upstream signals goes to which downstream outputs; and one or more TOM mux (Multiplexer) circuit that each converts multiple links that each contains only one set of audio video data to one link of multiple sets of audio video data to downstream device.

In still other embodiments of the digital video system, the system further comprising: a serial to parallel converter circuitry and software that converts XDI's 1-bit serial data into GPU's 32 or 64-bit or other bit width parallel data; and processing and displaying images in one of the at least 3 ways: 1) wherein the GPU further comprises circuitry and software to convert the Vector and Motion based data into Frame and Pixel based data to feed the TV Panel Processor for flat screen-based 3D displays that require the viewer to ware 3D filter glasses; or 2) to downgrade the 3D video data to 2D video data for 2D image displays; or 3) wherein GPU further comprises circuitry and software to convert the one 3D Vector and Motion-based data into at least two image data for at least two projectors to form the real 3D image in the midair.

Other embodiments include methods for digital data transmission system comprising: a system-wide link Bandwidth Management protocol check in which the actual maximum bandwidth of each physical link in the system is tested and the data flow assigned to that link is maintained below the actual maximum bandwidth at all times; and a dynamic Vector and Motion-based video content compression algorithm that only allows the requested amount of data from the sink and actual maximum bandwidth of the physical link in between whichever is lower; the method further comprising the steps of: sending out the test signal from the device on the upper stream of a physical data link with lowest data rate first at initial power up, handshake, or by request; waiting for the device in the other end of the physical data link to send an acknowledgement receiving an error free signal; then increasing the test signal sent from the upper stream device with higher data rate; and repeating the step of increasing the test signal sent from the upper stream device with higher data rate, until an error message or nor response at all is received from the downstream device and then recording the signal data rate where receiving the error free acknowledgement from the downstream device as the actual maximum bandwidth of this physical link.

Still other embodiments include an interconnect system comprising: a male connector for a cable; the male connector further comprising a connector core for making electrical connections; at least one removable and replaceable connector sleeve for adapting the connector to different shaped and sized connectors; each removable and replaceable connector sleeve further comprising; a slot opening along the side to allow the cable to slide through; a semi locking mechanism to lock onto the connector core when sliding forward; a locking mechanism to lock onto a cognate female connector; and a female connector with a matching locking mechanism to the male connector; and at least one safety break-away point.

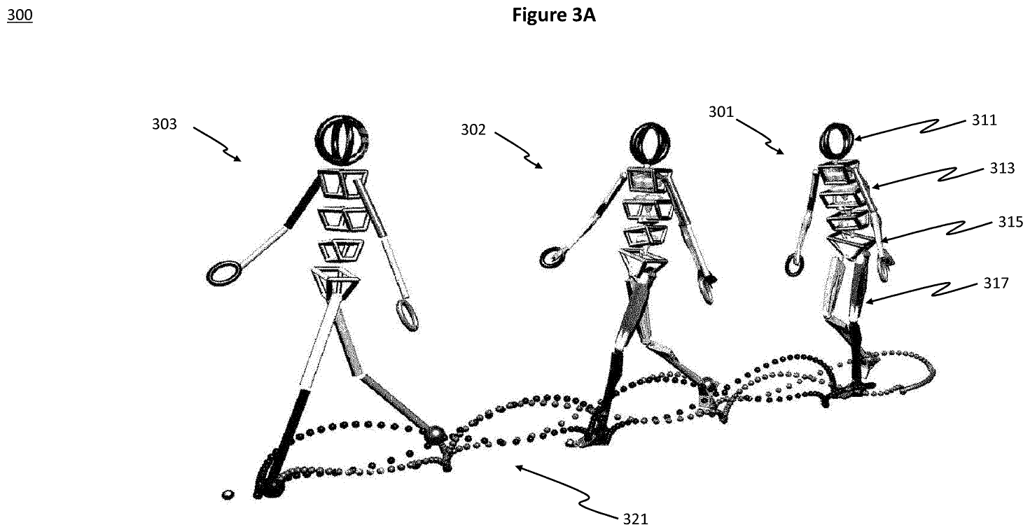

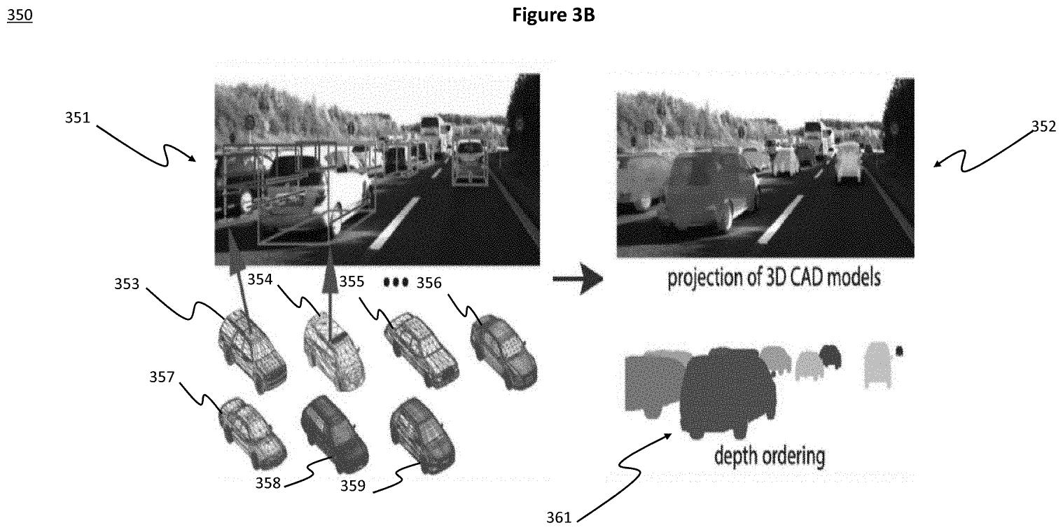

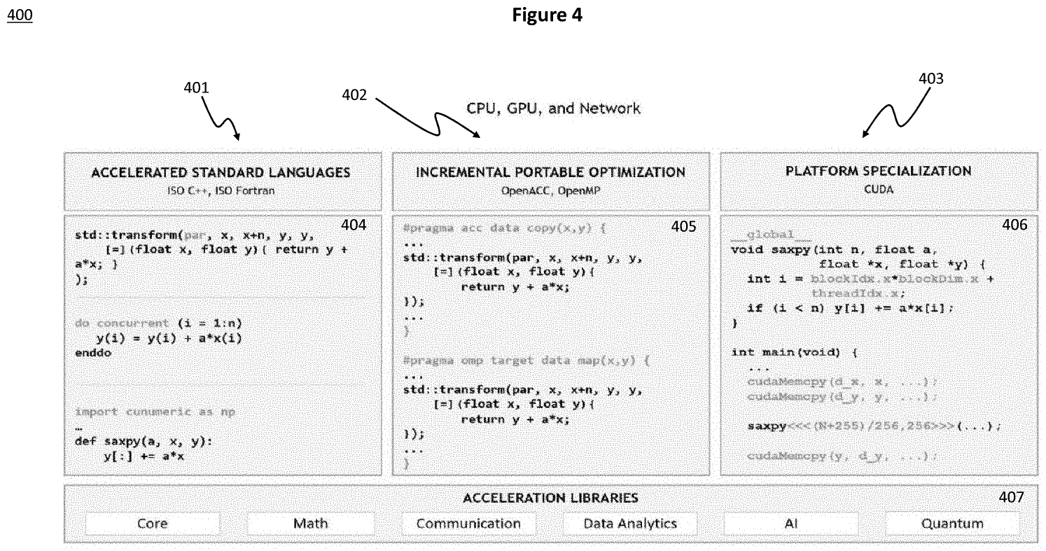

The advantages of embodiments of the current invention Vector and Motion based video XDI standard are set forth below:
1) Very low cable costs and very long cable runs: with the signal data rate reduced by hundreds of times, inexpensive, reliable and readily available copper cables now can send 8k video signals to as long as 1 km away (See FIG. 3 and FIG. 4).
2) Very low device bandwidth requirement and costs: similarly, with the signal data rate bandwidth costs are reduced by hundreds of times, the cost of ICs and other components are much lower, and the PCB layout design is much easier also lowering costs for manufacturing.
3) High system reliability and compatibility: the current invention includes a system-wide link bandwidth management protocol that tests the maximum bandwidth of every physical link in a system live, and records these data, and makes sure the signal data rate sent through any physical link never exceeds the maximum bandwidth of that link. This ensures high reliability and compatibility throughout the XDI system.
4) Clean solution for systems with mixed display resolutions: embodiments of the current invention include a dynamic vector and motion-based video content compression algorithm that only sends the video content requested by the displays and also that is allowed by the physical link. The compression decoder inside the display reconstructs the video to its native resolution, and each display shows the optimal video to its own specifications.
5) Very easy field termination and native locking connectors: the current invention XDI standard uses the widely available coaxial wires and connectors which are very easy to use for field termination with connectors and also have native locking connector features. The current invention also includes an embodiment for a new micro coaxial connector system that carries the same advantages yet still allows use with and fits the very thin profile of portable devices like smart phones, tablets and the like.
6) Flexible topologies and ease of installations: the current invention enables the XDI systems to be connected in a star topology, daisy chain topology or a mixture of star and daisy chain configurations, greatly increased the flexibility of the installations. In the daisy chain topology, all the user needs to do is to use short patch cords to link the adjacent devices in the easiest route, and link as many as needed at any time, the system does the full matrix switching without the need for matrix switcher. A multiple user conference table with the XDI system only needs one small cox cable carrying the signals of all users on the table to run to the projectors.
7) Serial data with only one conductor in cables: embodiments of the current invention use serial data, and coaxial cables for all connections. This greatly simplifies the field termination and circuit design. It can also use Category (Cat) cables, USB cables, wireless and other means of connections in other embodiments.
8) No extra compression hardware and license fees: since all signal decompressing is performed by the TV's built-in compression decoder, no compression decoder hardware is needed inside the source devices and obviating licensing requirements.
9) Internet friendly: in embodiments of the current invention, the audio video content from Cable TV STB, Satellite STB, Blu-ray Player, Hard Drive Player/Recorder use a similar compression method (H.264 or H.265) as the one used by Internet content providers, and with similar (very low) data rates. This makes streaming local compressed content over the Internet very easy.
10) Natively 3D: the XDI system can use the video captured by a normal 2D camera, analyze the video in real time, recognize the objects in the video, reconstruct the 3D models or Vectors of these objects, and their motions. These XDI Vector and Motion information is then recorded, sent through the video system and can be reproduced in 2D or 3D as, and at any resolution needed in different embodiments.

### DETAILED DESCRIPTION

The Extended Digital Interface (XDI) is a whole new video standard where video data is generated or captured and modeled as 3D Vector and Motion serial data or converted from parallel generated or captured video data to 3D Vector and Motion serial data. The XDI system is new at the system, signal format, device, and signal transmission levels. In the system level, it includes embodiments for the software video content, hardware devices, and signal transmission methods. In the signal format level, embodiments represent a brand-new video format that does not use the traditional Frame and Pixel based video, and rather uses a brand-new XDI Vector and Motion XDI formatted based video. In the device level, it includes the cameras, video editing devices, video transmission devices, video storage and playback devices, video switching devices, video converting devices and video display devices. Embodiments of the signal transmission level, it has the brand-new Vector and Motion XDI based object description signals formatted as serial data packets, and in other embodiments also works with the existing Frame and Pixel based video signals, and many other modulated or coded signals for storage efficiency and transmission data rate needs. See paragraph [0043] for details.

Embodiments of the XDI standard uses at least 2 image sensors to catch live video, then recognizes each in the view object's 3D model (Vector) and its movements (Motion) via its XDI video processor for live video; or uses the XDI video processor like the computer, video player or like devices acting as an enhanced CPU to generate each in the view object's 3D model (Vector) and its movements (Motion); then sends the descriptions of these 3D models (Vector) and their movements (Motion) through the cables and switching devices or storage devices with XDI encoder and decoder circuitry; at the display ends, the XDI projectors or display panels use a an XDI graphical processor to reconstruct the full motion video by using the descriptions of the 3D models (Vector) and their movements (Motion) for the XDI system.

There are 3 basic ways how a video is generated: live video from cameras or other capture devices, or devices cameras or capture devices that recognize the objects (Vectors) and their Motion from the transitional Frame and Pixel based video and generate the XDI Vector and Motion based video from it; or animated video created by a computer device

For the live video generated from cameras or other capture devices, if the signal from the cameras is Frame and Pixel based video, there are some facial recognition products (including Amazon Rekognition, Betaface, BiolD, Cognitec, DeepVision AI, Face++, FaceFirst, Kairos, SenseTime, Sky Biometry, Trueface.ai, see https://www.spiceworks.com/it-security/identity-access-management/articles/facial-recognition-software/#:˜:text=Facial %20recognition %20software %20(FRS)%20is,in %20the %20market %20in %202021) and software that recognizes human figures (FIG. 3A), and other traffic management products and software that recognizes motion vehicles (FIG. 3B), the XDI products will take the advantage on these facial recognition and vehicle recognition products, use 3D modeling to describe the objects already recognized by these products, and also to describe the movements of these objects by observing several adjacent frames of the video signal.

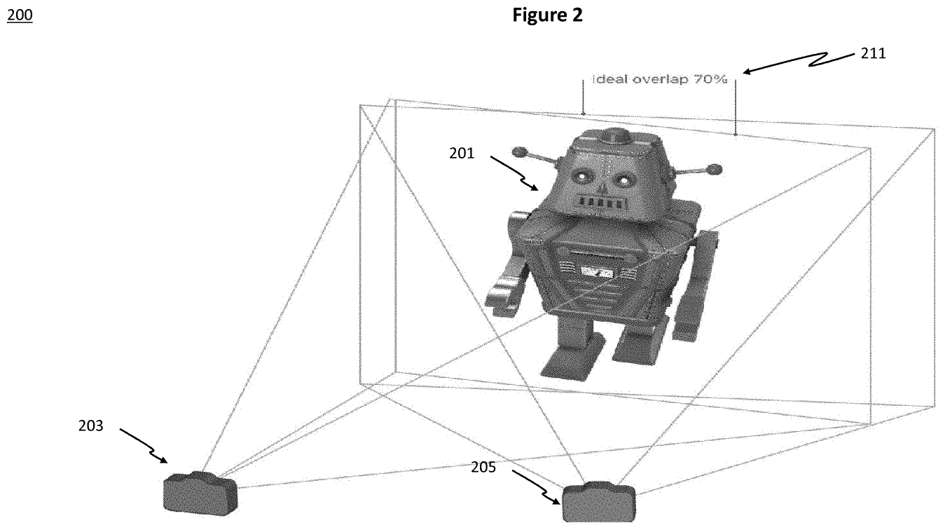

The live video can be directly generated into an XDI 3D Vector and Motion based video signal too, see FIG. 2. At least 2 image sensors are placed apart in distance and pointing to the same general direction; then each of the objects will be observed by these 2 image sensors at slightly different angles. The XDI video processor (enhanced CPU with XDI Vector and Motion software) can recognize each object's shape, position, facing, and movements, and use the Vector and Motion formulars to described each of the object in view, then converts these video data from parallel data in to serial XDI Vector and Frame based data.

For the artificial video created by a computer embodiment for XDI, it's much easier to get to the XDI Vector and Motion based video data, see FIG. 4. This artificial video used in applications like computer video games, PowerPoint presentations and other computer-generated content, are first created by the computer's CPU with the descriptions of the Vector and its Motion in computer languages like C, then data is sent to the computer's GPU to be converted into the Frame and Pixel based video. The data in between a computer's CPU and GPU is 32 or 64 bits of parallel data. The XDI System and formatted products takes advantage of this architecture, in embodiments an XDI device locates and receives the 32- or 64-bit parallel data, converts them into serial data for easy transportation and recording. Then this serial data is sent as XDI formatted serial data to other XDI devices in the system and ultimately to the XDI display unit for encoding into video by the XDI graphical processor. The XDI display unit's XDI graphical processor can generate a 2D or 3D display. Inside a 2D XDI display unit, the serial data is converted back to the 32- or 64-bit parallel data, then fed into an the XDI graphical processing unit, in some embodiments the XDI serial data is converted by the XDI GPU to Frame and Pixel based video signal to drive the display's screen. Other embodiments of a XDI 3D display device can have an XDI GPU with many variety ways to show 3D images; it can be two sets of 2D images on screen and picked up by 2 eyes of each viewer with 3D glasses and reproducing a 3D image in their brain; or it can have the 3D images projected in the midair by at least 2 projectors in different location and angles.

Because the XDI Vector and Motion XDI based video does not need to repeat the same or similar pixels thousands of times in a video frame, or 50 or 60 times a second in repeated frames in the current Frame and Pixel based video system, its data bandwidth is naturally much smaller, and can be up to 10,000 times smaller than the Frame and Pixel based video for the same view, and yet still has much higher resolution because once the objects in view is recognized as 3D models (Vector) and their movements (Motion), these 3D models can reconstruct video at the display at any resolution needed, can be many times higher than the fixed resolution of the current Frame and Vector based video.

In specific embodiments to capture and reproduce the very complex surface textures or colors like human skins or the environmental surfaces like stone or other surfaces, in addition to recognizing the object's 3D models (Vector) and their movements) Motion, the XDI format also capture a portion of the complex surfaces of each object by a prior art video camera in a traditional Frame and Pixel fashion, and sends these skin texture pattern data along with the Vector and Motion XDI data. In playback, the XDI video decoder first uses the Vector and Motion XDI to reconstruct the 3D models and their movements, then applies the skin pixel pattern to the surfaces they belong to so the natural skin textures and then colors can be applied to the surfaces of the 3D model. This is a major innovation over the current computer-generated video games or cartoon movies, in which no skin texture pattern is generated, and all skin surfaces look artifactually smooth.

Because all XDI video data started with describing each object's 3D model (Vector) and their movements (Motion), the XDI signal data is natively 3D. The user can reproduce these 3D video data in 3D in any desired formats; for example, to reproduce true 3D images in the midair by several laser projectors converging their lights together; or in fake 3D images on a flat 2D surfaces, and let the 3D glasses the viewer wear to pick one image for the left eye and another image for the right eye, and to allow the viewer's brain to reconstruct the feel-like 3D images in their mind. Of course, the XDI video data can be used to reproduce the simpler 2D images easily; and viewer can choose the viewer angle of the 2D image from the 3D image data.

Methods to project 3D video data are known and include but are not limited to [Add: David F. Rogers and J. Alan Adams, Mathematical Elements for Computer Graphics, Second edition, McGraw-Hill, New York, 1990, Chapter 3; Zhangjie Cao, Qixing Huang, and Karthik Ramani, 3D Object Classification via Spherical Projections, [Add Publisher]; Byoungho Lee, Soon-gi Park, Keehoon Hong, and Jisoo Hong, Multi-projection 3D displays using multiplexing techniques in autostereoscopic displays, SPIE, the international society for optics and photonics, 6 Jun. 2017; Glenn McDonald, New Technique Generates Free-Floating 3D Images. Just Don't Call It a Hologram, published on Jan. 24, 2018 at 1:01 PM, summarizing Optical Trap Display; Professor Daniel Smalley (center) with students Erich Nygaard (left) and Wesley Rogers (right). Other such methodology is known in the art.

Prior Art 2D Frame and Pixel Based Video Signals and MPEG-2 Compression

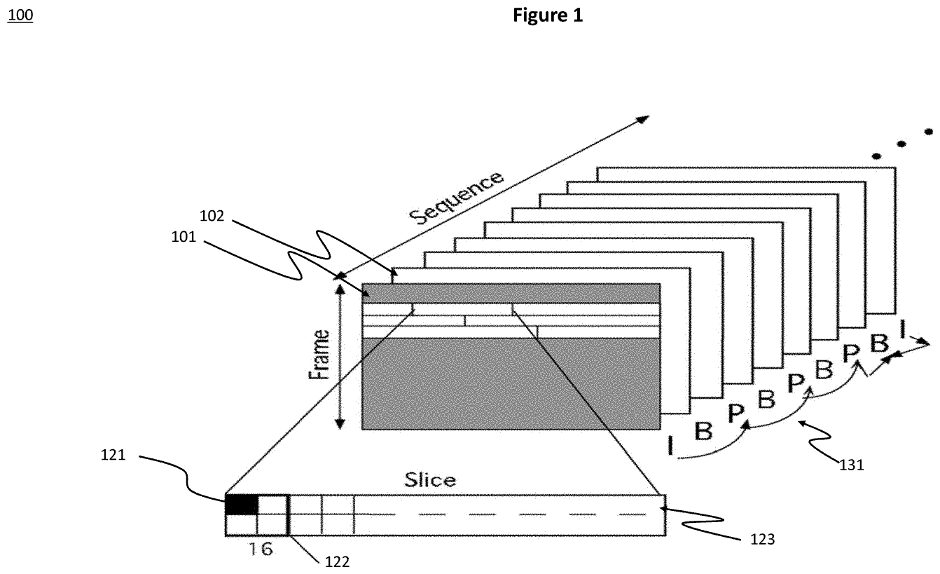

Referring to FIG. 1; schematically shown is a prior art Frame and Pixel based video signal 100. The video camera lens projects the lights from 3D objects in the real world through lens onto a 2D image sensor. A shutter between the lens and the image sensor only opens for a very short period of time to project the lights onto the image sensor, effectively converted moving images into a still image for each moment the shutter is open. The shutter opens either 24 times (in motion picture cameras) or 50 times (in video cameras used in most of European and some Asian countries, and some other countries) or 60 times (in video cameras used in the US, Japan, and some other countries). This number of shutter's opening times is called the frame rate. With each still image captured by the image sensor is called a video Frame. Item 101 in FIG. 1 is one video frame; 102 is the next video frame, and so on, etc. The image sensor has many horizontal rows or Lines of sensor elements; each Line has many sensor elements or Pixels. That's why this kind of video system is called Frame and Pixel based video. For example, the most commonly used 1080p 60 Hz signal has 60 Frames per second, 1080 Lines per frame, 1920 Pixels per Line.

Continuing referring to FIG. 1. There are a few different video compression methods to compress the prior art Frame and Pixel based video. The most common one is MPEG-2. In MPEG-2, the Pixels on a video Frame are grouped into 8×8 Pixel group called a block 121; then 4 such blocks form a macroblock 122; several of macroblocks form a slice 123. The video content in each macroblock is compared with the 8 sequential Frames 131 to see any changes, and these change patterns are used to compress the video signal within each macroblock. There are no protocols to recognize the objects and use 3D models or Vectors to describe them in the whole frames of video contents. The effectiveness of these types of compression is limited and can lead to loss of video content.

XDI Systems 3D Live Video Capturing

Referring now to FIG. 2; schematically shown is one example 200 XDI 3D image capturing by 2 or more image sensors. Two or more image sensors 203 and 205 aim at the same 3D object 201 from slightly different angles, preferred to have the two-image sensor view overlap about 70 degrees 211. The image data captured by these two image sensors are sent to an XDI video encoder to perform 3D Models Recognition and Motion Encoding as described in paragraph [0070] through [0071]. The detailed description on the 3D recognitions methods is listed in paragraph [0043].

In embodiments of the internal circuits of a 3D live video capture device, there are least two image sensors placed apart in different locations pointing to the same view field; a video buffer memory IC to store the image data from these 2 image sensors; a Video Processor IC to use software to analyze the data from these at least 2 image sensors, recognize each object and its position, size, shape, orientation, movement, surface texture or other features, send out digital video data describing these details in 32 or 64 bit or other bit width data in parallel data format; a parallel to serial data converter IC converts the data into 1-bit serial data; a channel coding IC change the continuous serial data into packetized serial data for IP transmissions; a MCU IC to manage all these activities and communicate with other devices.

In embodiments of the internal circuits of a 3D live video converted from Frame and Pixel based video format device, there is a traditional 2D image sensor IC to generate the traditional Frame and Pixel based video data; a video buffer memory IC to store the image data from the 2D image sensor; a Video Processor IC to read the several adjacent video frames of data from the buffer memory IC, compare the differences between them, recognize each object and its position, size, shape, orientation, movement, surface texture or other features, send out digital video data describing these details in 32 or 64 bit or other bit width data in parallel data format; a parallel to serial data converter IC converts the data into 1-bit serial data; a channel coding IC change the continuous serial data into packetized serial data for IP transmissions; a MCU IC to manage all these activities and communicate with other devices. The Video Processor IC needs to read and compute a lot of pixels of data in multiple frames (for example, a 4k video has 3840×2160 pixels per frame, 60 frames in a second) in real time to be classified as “live” video, it needs a lot computing power and can get very hot. There are both IC hardware efficiency improvements and the software efficiency improvements that are known, and commercially available, or in development, or can be applied here by a skilled engineer to increase the computing power and reduce the heat it generates.

In another embodiment of the live 3D video capture device, instead of using 2 image sensors in adjacent locations to capture video images, there's a LiDAR (light detection and ranging) sensor to send laser beam to scan the field of view, capture the light bounded back from the objects, convert them into video data; a Video Processor then uses the timing of the returned laser bounced back from the objects in the view to determine the shape, size, distance, surface texture, movements; send out digital video data describing these details in 32 or 64 bit or other bit width data in parallel data format; a parallel to serial data converter IC converts the data into 1-bit serial data; a channel coding IC change the continuous serial data into packetized serial data for IP transmissions; a MCU IC to manage all these activities and communicate with other devices.

XDI Systems 3D Models Recognition and Motion Encoding

Referring now to FIG. 3A; schematically shown is one example of a XDI 3D model 300 recognition and motion encoding of a human. The image of one human is at position 301 at one moment, then is at position 302 a moment later, then it is at position 303 another moment later. Based on the similarities with the images at these different moments, the XDI video encoder is able to recognize the object 311 as a human head, 313 as human body, 315 as human arms, and 317 as human legs, and all these objects are connected to each other as one whole human body. The encoder is also able to describe each object with a 3D model, and also describe its movement. For example, the encoder recognizes the object 311 as a human body, and setup a 3D model and all the smaller features on it like eyes, nose, mouth, ears etc., and establish the head's orientation (where it's faced; in this case the left and slightly front away from the screen), and its relatively movement (in this case almost steady speed in straight line with slightly up and down movements associated with each step). The other 2 objects 317 are recognized as two legs, with more complex movements 321: one foot stay on the ground for a brief moment while the other leg is lifted and moved forward; then the foot of that leg is stationary on the ground for a brief moment when the first leg now is swinging forward; and repeat. In addition to recognizes the objects, the XDI encoder also recognizes the shape, texture and the color of the skin or cloth that covers each part of the body, record them with math models. The skins and the cloths form the surfaces of the objects 311, 313, 315 and 317, etc. and moves with them.

Referring now to FIG. 3B, schematically shown is one example 350 of XDI 3D models recognition and motion encoding on cars. The image 351 with 7 cars 353 thru 359 is shown. The XDI video encoder recognizes these cars, setup 3D model for each car, and their positions in the image using the depth ordering 361, and also each car's movement, send these data through the XDI connections. Then the XDI decoder at the display end can use these data to rebuild the 3D models of each car into the image 352.

Referring now to FIG. 4, Schematically shown is examples 400 of an embodiment of computer coding that can be used in objects' shapes, sizes, orientations and movements, and texture or surface features or other parameters. These computer 3D language code 401, 402 and 403 are just some examples. The XDI data can use a wide range of computer languages including but not limited to C/C++ and Fortran, with third party wrappers also available for Python, Java, R, and several other programming languages. The XDI encoder will include the language used in XDI video data in the handshake data to inform the XDI decoders in the system so the decoders can rebuild the 3D models based on it.

In embodiments of a device that generates animated 3D video, there's a CPU IC to create image object's position, size, shape, orientation, movement, color, surface texture or other Vector and Motion features based on the scripts loaded by the user via USB drive, DVD disc or internet download; a video memory to store these Vector and Motion data; send out digital video data describing these details in 32 or 64 bit or other bit width data in parallel data format; a parallel to serial data converter IC converts the data into 1-bit serial data; a channel coding IC change the continuous serial data into packetized serial data for IP transmissions; a MCU IC to manage all these activities and communicate with other devices.

XDI Distribution Systems

Provided are embodiments for the XDI Vector and Motion video-based systems, devices, circuits, connectors, software, and methods for sending and receiving compressed audio video serial digital signals. Many of the embodiments representing inventions in this application can be used outside the XDI systems and devices, and can be applied to other video transmission systems without limitation. The prior art uncompressed serial digital formats like SDI, semi parallel digital formats like HDMI, DVI and DP, internet streaming formats among others can be converted to and from XDI format for integration in or out of an XDI system and represent hybrid embodiments in an XDI system.

Referring now to FIG. 6; schematically shown is a prior art system 600 using uncompressed audio video signal format like HDMI, DP or SDI in a star topology. This prior art system uses the signals of the highest native resolution among the connected displays, resulting with some displays having no pictures or scaled down pictures of reduced resolution. This system also suffers from very short cable runs between devices and very high device costs due to the excessive signal data rate required. The 8k compressed audio video contents 601 are fed into the source devices: Internet Streaming STB 603, Cable TV STB 604, Satellite TV STB 605, 8k Blu-ray Player 606 (these are just examples; other source devices not shown are contemplated having the same functional concept as the ones shown here). These source devices decompress the originally compressed audio video signals to uncompressed ones 608 with a very high signal data rate. In this example, the 8k 60 Hz 4:4:4 is an uncompressed signal for a total 64 Gbps. This super high signal data rate reduces the useable maximum copper cable length to less than 2 meters. The signals are fed into a central matrix switcher 610 with very high bandwidth capacity (and correspondingly high cost). The matrix outputs the same uncompressed signals 612 with a very short cable length, and feed the signals to display devices: an 8k TV 614, a 4k TV 615, a 1080p TV 616, a 720 TV 617 (these are just examples; other display devices not shown are contemplated having the same functional concept as the ones shown here). Since the prior art matrix switcher 610 can only work with one signal format with one video resolution at a time, the system must choose a uniformed video resolution. In this FIG. 1, example we use the system resolution to match the highest resolution among the displays, 8k. The 8k display 614 shows a normal picture. The 4k display 615 shows a scaled down picture or no picture. The 1080p display 616 and 720p display 617 cannot show any picture.

Referring now to FIG. 7; schematically shown is the same prior art hardware system 700 as the one in FIG. 6 system 600, the only difference is now the system video resolution is chosen to match the lowest resolution among the displays, 720p. This prior art system uses the signals of the lowest native resolution among the connected displays, resulting with some displays having pictures scaled up from a resolution much lower than their native resolution resulting in reduced resolution images. This system also suffers from short cable runs between devices and high device costs due to the excessive signal data rate required. By sending this signal through the system, the data rate of the signal 708 and 712 to and from the AV matrix switcher 710 is reduced to 2 Gbps, allowing the maximum cable length to reach 30 m. Now only the 720p TV 717 shows a normal picture. All other displays 714, 715 and 716 (TVs) will show a very low-resolution pictures scaled up from 720p, and this defeats the purpose of using the 8k or 4k audio video contents and displays.

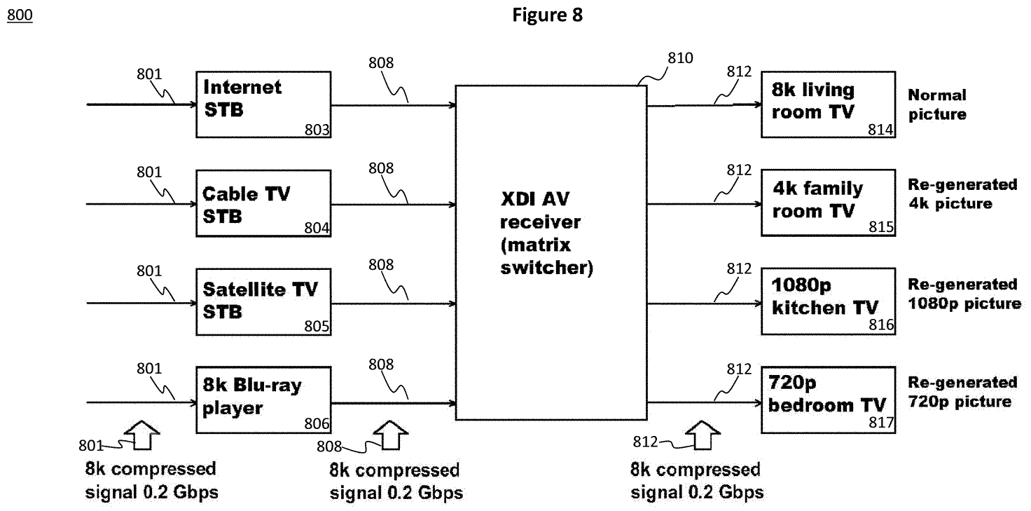

Referring now to FIG. 8, schematically shown is an embodiment of the current invention XDI system 800 in Star Topology. In this embodiment the cable run length can be much longer, and the device cost is much lower due to dramatically lower signal data rate required for transmission. Each display reconstructs the video to its optimized native resolution. The 8k compressed audio video content 801 are fed into XDI source devices: Internet Streaming STB 803, Cable TV STB 804, Satellite TV STB 805, 8k Blu-ray Player 806 (these are just examples; other source devices not shown are contemplated having the same functional concept as the ones shown here). These XDI source devices do NOT decompress the signals, instead they send out the same compressed signals (with only signal format changes to an embodiment of one of the XDI formats which are serial data in standard IP packets) 808. The data rate of these compressed 8k signals is only 0.2 Gbps in this example, allowing use of the low-cost copper coaxial cables to send these 8k signals to as far as 1 km away. In some embodiments a XDI Node (Matrix Switcher) 810 takes in these signals, switches and splits them, and sends out the same compressed signals 812 to displays: an 8k TV 814, a 4k TV 815, a 1080p TV 816, a 720 TV 817 (these are just examples; other display devices not show are contemplated having the same functional concept as the ones shown here). Since the signals in this XDI system are not resolution (pixel) based, rather they are video vector and motion based compressed signals, the system does not have to choose only one resolution as in the prior art systems in FIG. 1 and FIG. 2. These video vector and motion based compressed signals are decompressed inside each display by its built in Compression Decoder to reconstruct the video to match the native resolution of its screen, and each display can show its optimized pictures in different resolutions from other displays from the same video vector and motion based compressed signals in the system.

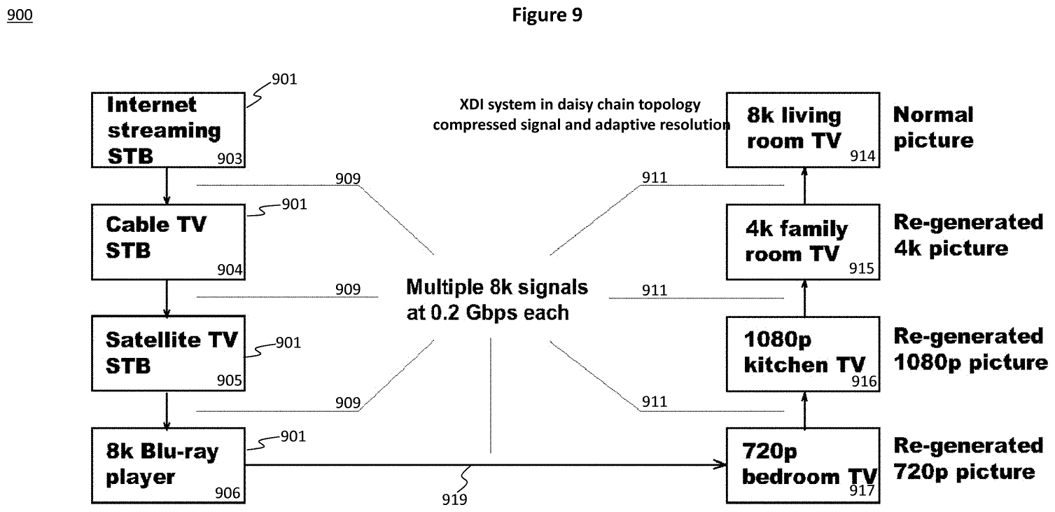

Referring now to FIG. 9, schematically shown is the current invention XDI system 900 in Daisy Chain Topology. The cable run can be much longer and the device cost is much lower due to dramatically lower signal data rate being required. Each display reconstructs the video to its optimized native resolution. Also, a central switching device is not needed, the system is easier to install and the number of devices is scalable in live plug and play scenarios. This embodiment is very similar to the system in FIG. 8, but without the central Node (Matrix Switcher) 810. All devices in this system have at least one XDI input and one XDI output for receiving and sending signals 901. Device 903's XDI output is connected to Device 904's XDI input by a single coaxial cable 909; Device 904's XDI output is connected to Device 905's XDI input, and so on via a single coaxial cable 919 to Devices 906, 917, 916, 915, 914. The single coaxial cable 911 runs between the displays. In this daisy chain system, the single coax cable in between XDI devices carries all the signals accumulated from all upstream source devices. The displays devices 914 through 917 each has its built-in Daisy Chain Processor to select with signals it extracts from the multiple signals inside the coax cable and XDI graphical processing unit to decode for display on a local screen as true projected 3D video, simulated 3D video, or downgraded 2D video. This allows the daisy chain to function as a true matrix switcher system without a matrix switcher. These video vector and motion based compressed signals are decompressed inside each display by its built in Compression Decoder to reconstruct the video to match the native resolution of its screen, and each display can show its optimized pictures in different resolutions from other displays from the same video vector and motion based compressed signals in the system.

XDI Source Devices

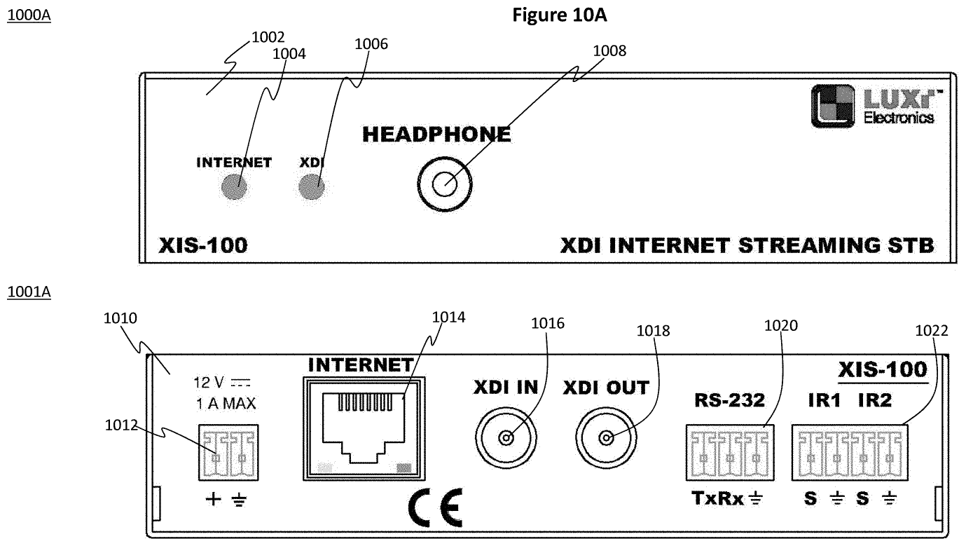

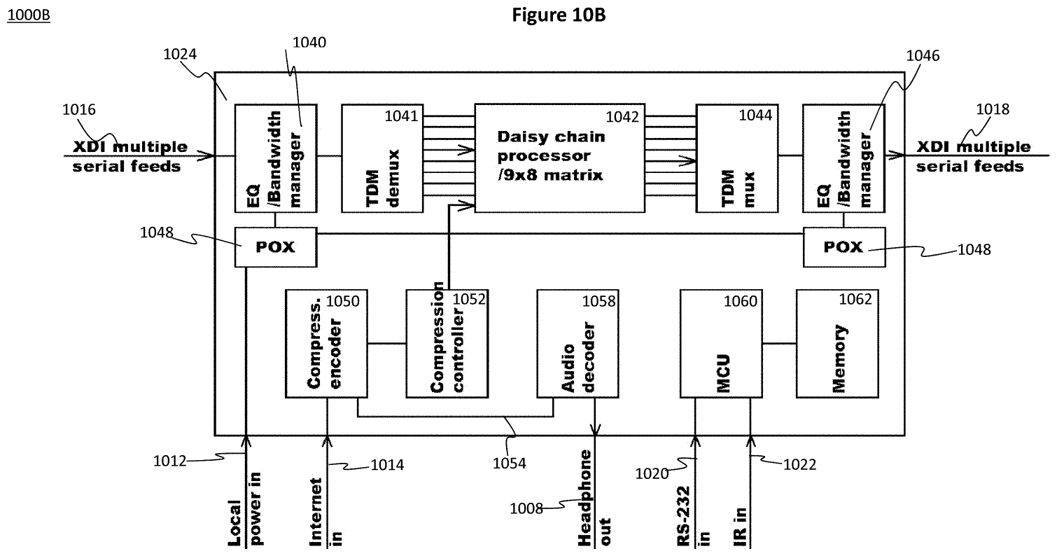

Referring now to FIG. 10A and FIG. 10B, schematically shown are XDI Internet Streaming STB source device's front panel 1002 and its features 1000A, rear panel 1010 and its features 1001A and internal circuit block diagram 1000B, respectively.

Now continuing on referring to FIG. 10A and FIG. 10B. The front panel 1002 has indicators for Internet 1004 and XDI 1006 signals as well as for a headphone connection 1008. The rear panel 1010 has power 1012, Internet connector 1014 (RJ-45), XDI in 1016, XDI out 1018 connectors and control RS232 1020 and Infrared 1022 connectors. The XDI Internet Streaming STB circuit block diagram 1000B's MCU (Micro Control Unit) IC 1060 together with Memory IC 1062 and the local firmware and system software controls all functions of the XDI system and all internal circuits of this device, by the user input commands via RS-232 connector 1020 and IR connector 1022 from this device and all other connected devices, and by the system protocols. A local power source comes in via connector 1012 to the PDX (Power over XDI) circuit 1048 sharing the power among all connected XDI devices thus the XDI system does not need for every device to be powered locally. The power is inserted into the single coax cable with the serial audio video data via phantom power technology. Note that the functions described in this paragraph are common to all XDI electronics devices and will not be repeated in the descriptions to other XDI devices below though the relevant figures show these common elements.

Now continuing on referring to FIG. 10A and FIG. 10B. The multiple XDI compressed serial feeds in standard IP packets via a coax cable enters the device circuit board 1024 via a coax connector 1016. The EQ circuit 1040 equalizes (amplifies) and reshapes the signals to sharp digital square waves. The Bandwidth Manager 1040 works in conjunction with the Bandwidth Manager in the immediately connected device upstream to test the maximum physical link bandwidth, and also with the Compression Controller 1052 in this device and all other related devices in the system to ensure the signal data rate never exceeds the physical link's maximum bandwidth. A TDM (Time Domain Multiplexing) demux (De-Multiplexer) 1041 separates the multiple sets of serial audio video data in one coax cable into multiple lines that each carry one set of serial audio video data, and feeds them into a Daisy Chain Processor (Matrix Switcher) 1042. The 1042 takes all demuxed signals from 1041, plus the serial audio video data from local source 1014 (converted by decoder 1050 and regulated by controller 1052), chooses which upstream data are passed through to downstream devices, and which one is replaced by local data stream. A TMD mux (Multiplexer) 1044 takes in the multiple lines that each carry one set of serial audio video data from the Daisy Chain Processor 1042, and combines them into one line of multiple sets of serial audio video data, and feeds into EQ/Bandwidth Manager 1046 and sends through a coaxial connector 1018 to downstream devices. Note that all descriptions in this paragraph are common to all the daisy chain portion of the circuits of all XDI source devices with daisy chain feature, and will not be repeated in the descriptions to other XDI devices below though the relevant figures show these common elements. For the XDI source devices without daisy chain feature, the items 1016, 1040, 1041, 1042, 1044 are not needed.

Now continuing on referring to FIG. 10A and FIG. 10B. The Internet signal enters the device via a RJ45 connector 1014 (or wireless antenna connector, not shown), to an Internet Streaming Decoder 1050, and is converted into the XDI serial digital format without decompressing, and then is fed to Compression Controller 1052 which works in conjunction with Bandwidth Managers 1040 and 1046 to make sure the signal data rate never exceeds the physical link max bandwidth. Item 1050 also de-embeds audio to signal, and feeds 1054 to an Audio Decoder 1058 to drive the headphone via connector 1008. POX 1048 (Power over XDI) provides the remote power capability.

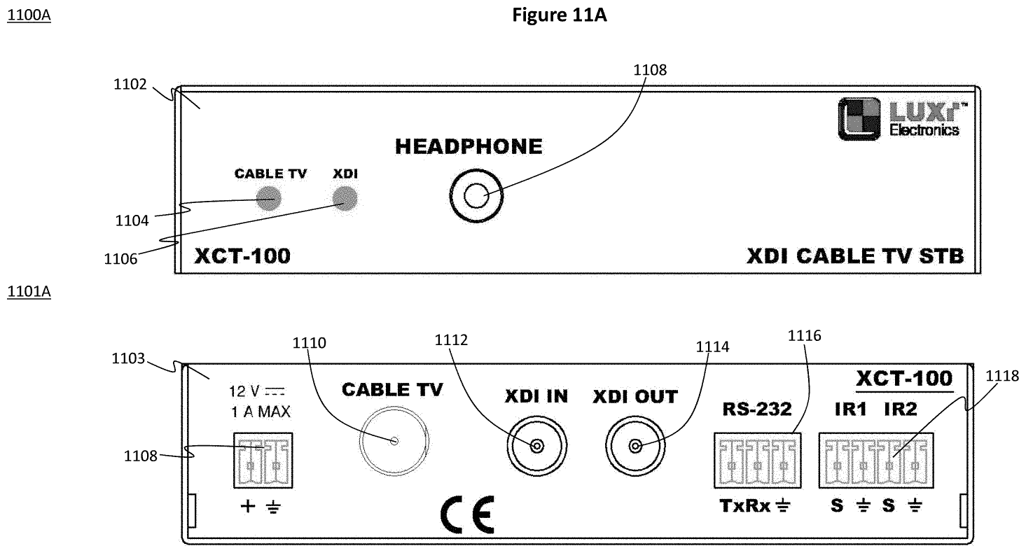

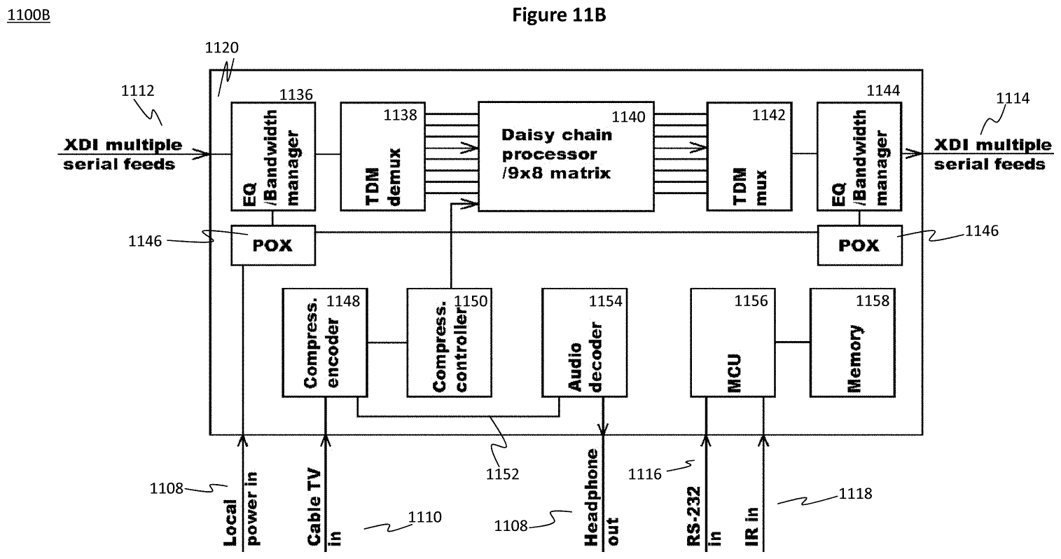

Referring now to FIG. 11A and FIG. 11B, schematically shown are XDI Cable TV STB source device's front panel 1102 and its features 1100A, rear panel 1103 and its features 1101A and internal circuit block diagram 1100B, respectively. Its features and internal circuits are the same as device shown in FIG. 10A and FIG. 10B, with the only differences being the item 1110 is now a coaxial connector for Cable TV input, and item 1148 now is a Cable TV decoder.

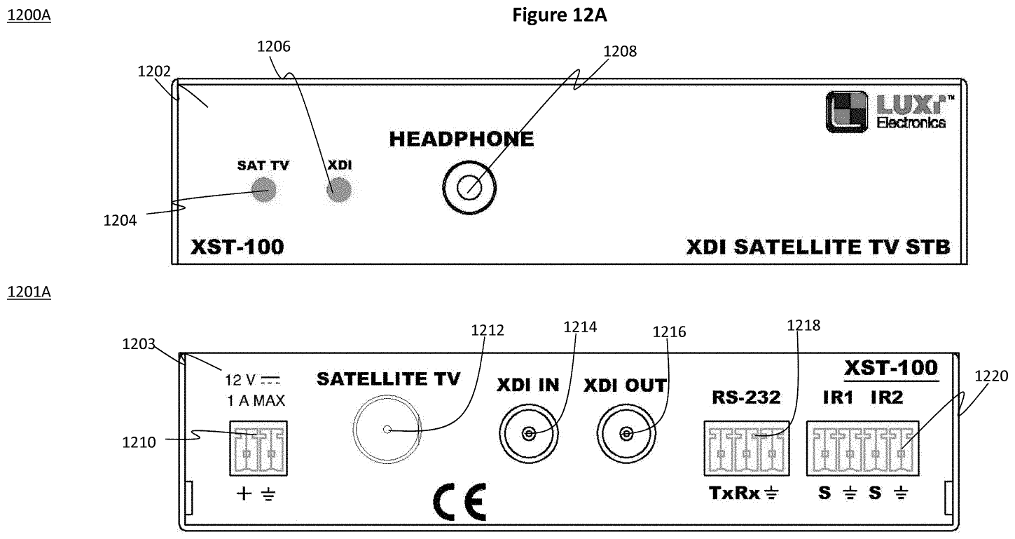

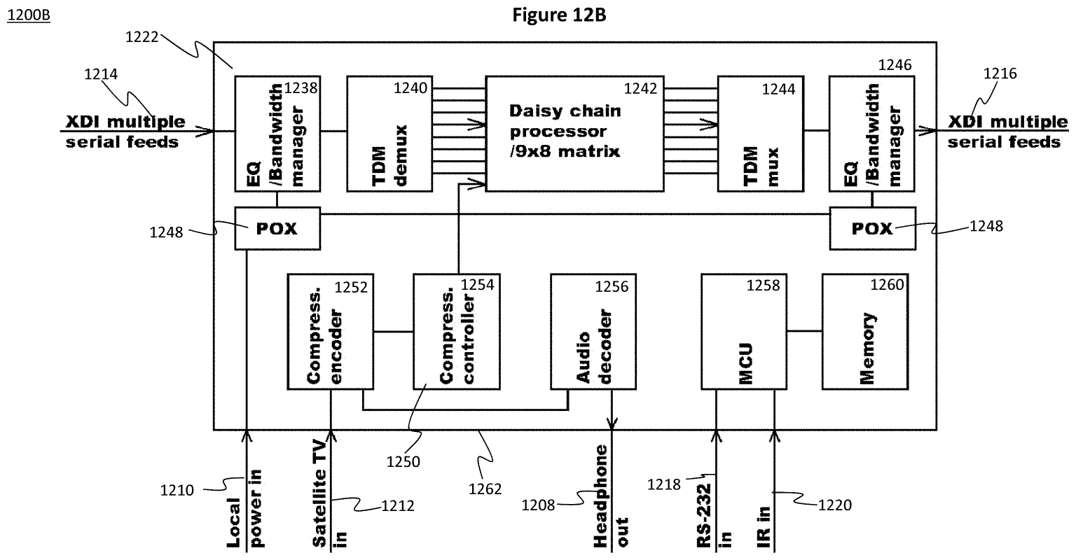

Referring now to FIG. 12A and FIG. 12B, schematically shown are XDI Satellite TV STB source device's front panel 1202 and its features 1200A, rear panel 1203 and its features 1201A and internal circuit block diagram 1200B, respectively. Its features and internal circuits are the same as device shown in FIG. 10A and FIG. 10B, with the only differences being the item 1212 is now a coax connector for Satellite TV input, and item 1252 now is a Satellite TV decoder.

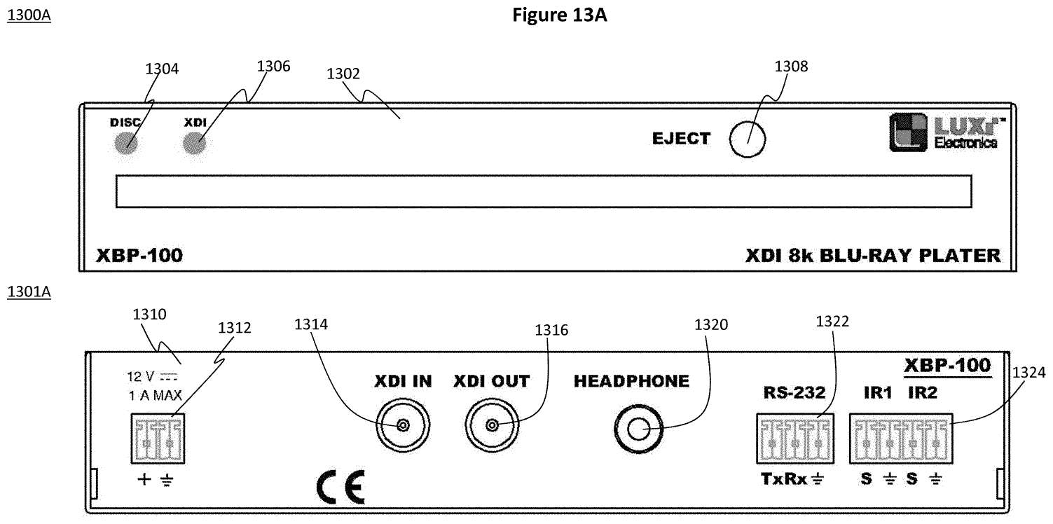

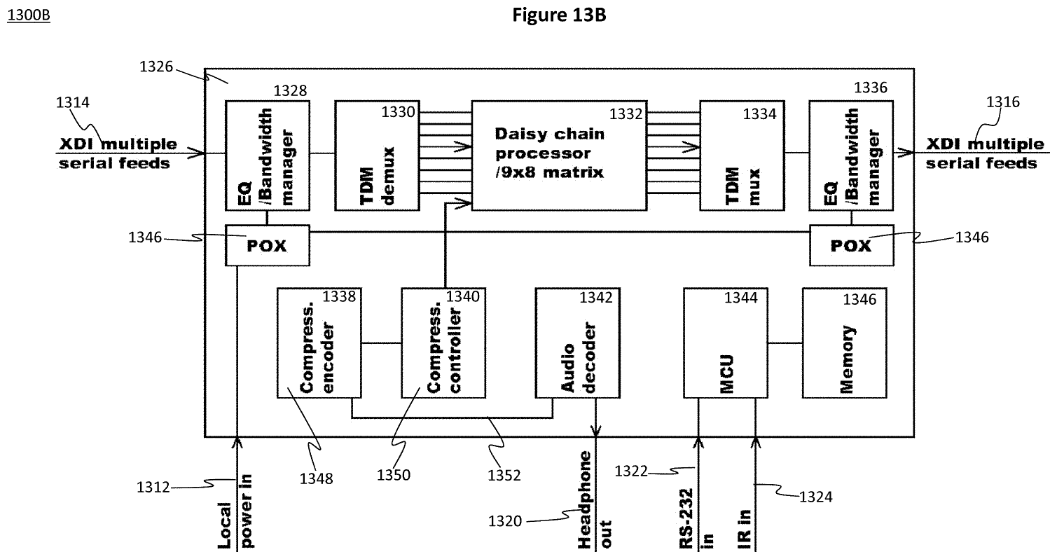

Referring now to FIG. 13A and FIG. 13B, schematically shown are XDI 8k Blu-ray Player source device's front panel 1302 and its features 1300A, rear panel 1310 and its features 1301A and internal circuit block diagram 1300B, respectively. Its features and internal circuits are the same as device shown in FIG. 10A and FIG. 10B, with the only difference being the item 1338 now is a Blu-Ray laser head/disc servo/decoder that includes all the mechanical, optical and electrical components of a Blu-Ray player core.

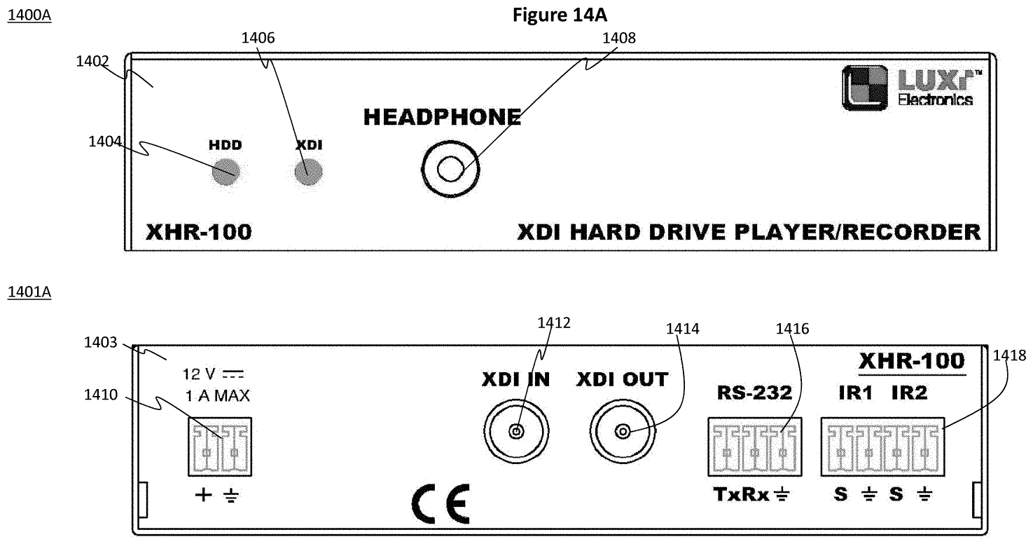

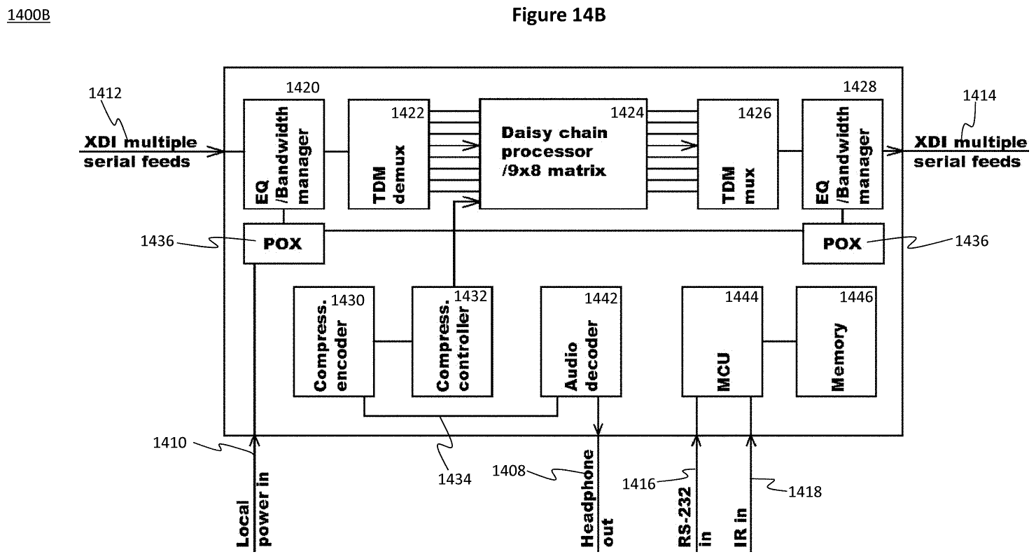

Referring now to FIG. 14A and FIG. 14B, schematically shown are Hard Drive Player/Recorder source device's front panel 1402 and its features 1400A, rear panel 1403 and its features 1401A and internal circuit block diagram 1400B, respectively. Its features and internal circuits are the same as device shown in FIG. 13A and FIG. 13B, with the only difference being the item 1430 now is a hard drive read/write/disc servo/decoder that includes all the mechanical, magnetic and electrical components of a hard drive player/recorder core.

XDI Compression Encoder

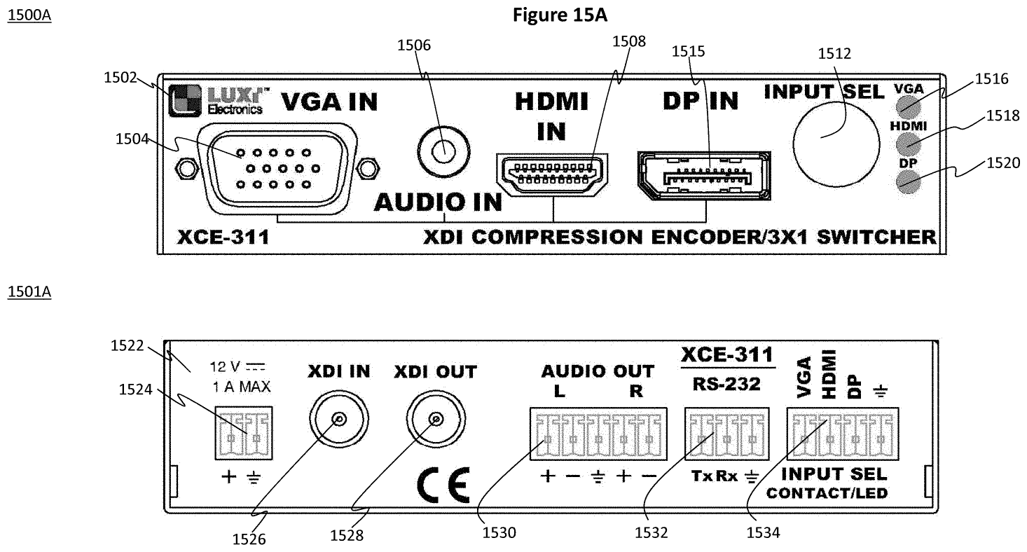

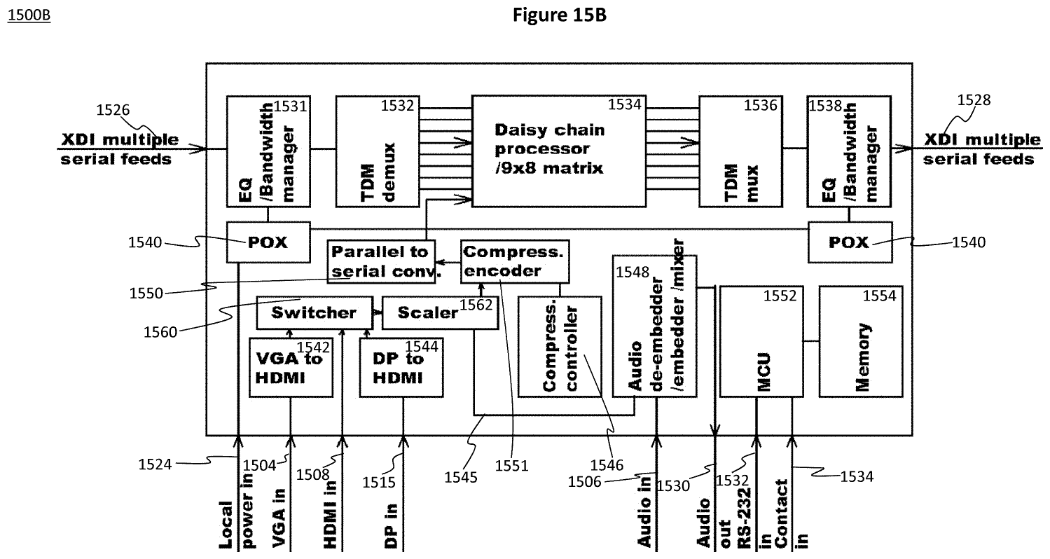

Referring now to FIG. 15A and FIG. 15B, schematically shown are XDI Compression Encoder/Switcher's front panel 1502 and its features 1500A, rear panel 1522 and its features 1501A and internal circuit block diagram 1500B, respectively. The function descriptions of item 1526, 1531, 1532, 1534, 1536, 1538, and 1528 are identical to the ones described in paragraph [0056], and also described items 1524, 1540, 1552 and 1554 in paragraph [0055], so there is no need to repeat these descriptions here. The local uncompressed signal inputs can be one or multiple. In this example we show 3 types of local uncompressed video inputs. A VGA input enters via connector 1504 to a VGA to HDMI converter 1542 to be converted into a digital format like HDMI, then is fed into a HDMI switcher 1560. A HDMI input enters via connector 1508 and directly to switcher 1560. A DP signal enters via connector 1510 to a DP to HDMI converter 1544 to be converted to HDMI, and then is fed into a switcher 1560. The switcher 1560 chooses which signal to be sent to scaler 1562 that scales the video to the requested resolution. The output from 1562 goes to Compression Encoder 1551, in which the uncompressed signals are compressed, then to Parallel to Serial Converter 1550 in which the semi parallel signals are converted to serial data. This compressed serial data goes into the Daisy Chain Processor (Matrix) 1534, and either is not used or is replaced by one of the serial data signals from upstream devices, decided by the user request. The Compression Controller 1546 works with Bandwidth Managers in all devices to determine the proper signal data rate that can meet the displays' requests while not exceeding the physical links max bandwidth, and controls the Compression Encoder 1551 to have the right compression ratio. Audio De-embedder/Embedder/Mixer 1548 gets audio signals from scaler 1562 and local audio input 1506, changes the digital audio to analog audio, switch or mix different audio inputs, and then sends out a local analog audio via audio out connector 1530, and inserts audio into digital video via scaler 1562 if needed. In some embodiments where there's only one local video input needed, item 1504 or 1508 or 1510, 1542 or 1544, 1560, 1562 are optional and are not needed. In some other embodiment where the daisy chain feature is not needed, items 1526, 1531, 1532, 1534, 1536 are not needed. In yet other embodiment where audio embedding/de-embedding is not needed, items 1506, 1548 are optional.

XDI Compression Decoder

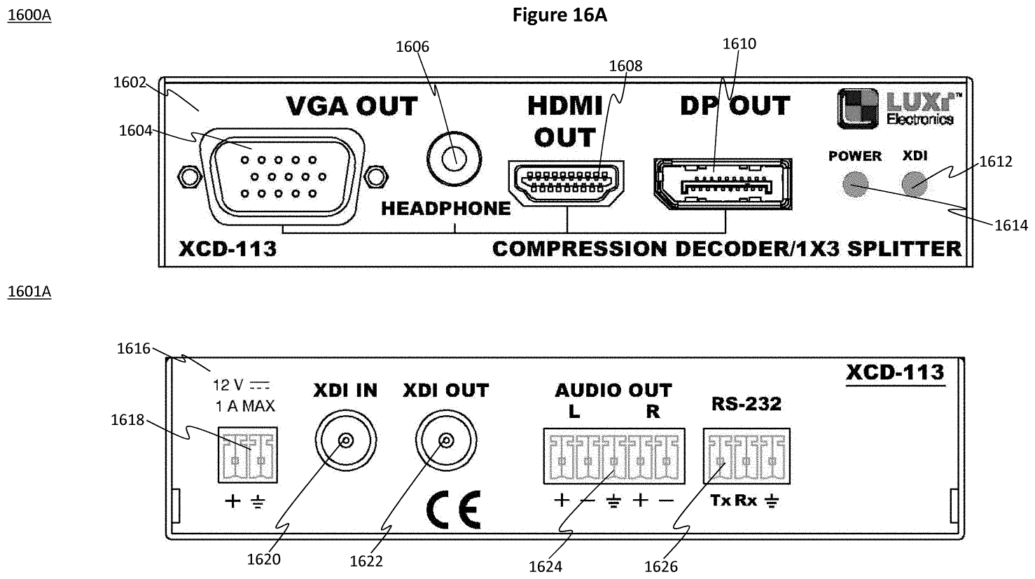

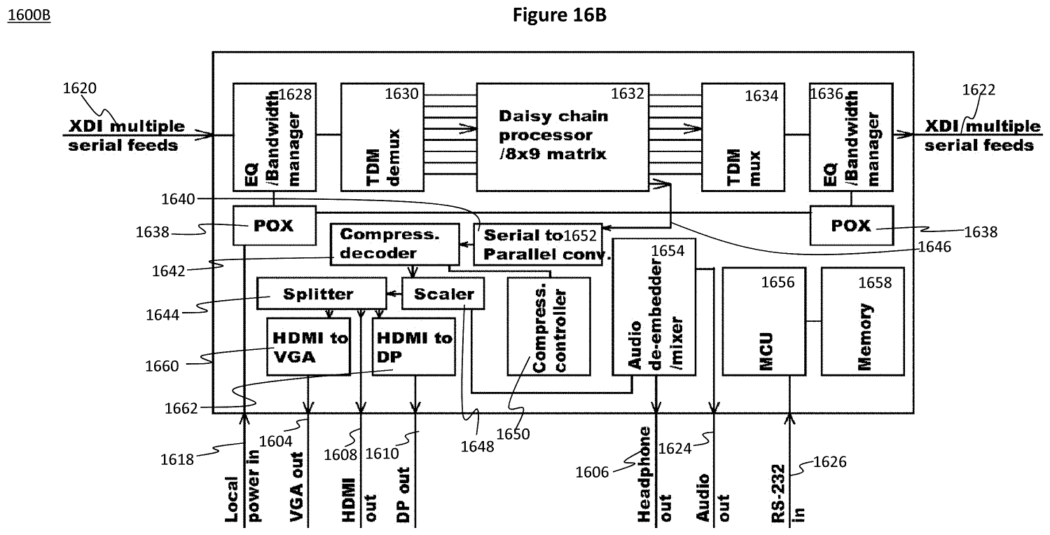

Referring now to FIG. 16A and FIG. 16B, schematically shown are XDI Compression Decoder/Splitter's front panel 1602 and its features 1600A, rear panel 1616 and its features 1601A and internal circuit block diagram 1600B, respectively. The multiple XDI compressed serial feeds via a coax cable enters the device via a coax connector 1620. The EQ circuit 1628 equalizes (amplifies) and reshapes the signals to sharp digital square waves. The Bandwidth Manager 1628 works in conjunction with the Bandwidth Manager in the immediately connected device upstream to test the maximum physical link bandwidth, and also with the Compression Controller 1650 in this device and all other related devices in the system to ensure the signal data rate never exceeds the physical link's maximum bandwidth. A TDM (Time Domain Multiplexing) demux (De-Multiplexer) 1630 separates the multiple sets of serial audio video data in one coax cable into multiple lines that each carry one set of serial audio video data, and feeds them into a Daisy Chain Processor (or Matrix Switcher) 1632. The Daisy Chain Processor (DCP) 1632 takes all demuxed signals from 1630, chooses which upstream data are passed through to downstream devices, and which one to be extracted to local serial data 1646, to be decoded for local display. A TMD mux (Multiplexer) 1634 takes in the multiple lines that each carry one set of serial audio video data from DCP 1632, and combines them into one line of multiple sets of serial audio video data, and feeds into EQ/Bandwidth Manager 1636 and sends through a coax connector 1622 to downstream devices. Note that all descriptions in this paragraph are common to all the daisy chain portion of the circuits of all XDI display devices with daisy chain feature, and will not be repeated in the descriptions to XDI display devices below though the relevant figures show these common elements. For the XDI source devices without daisy chain feature, the items 1630, 1632, 1634, 1636, and 1622 are not needed.

Continuing on referring to FIG. 16B, the functions of items 1618, 1638, 1626, 1654 and 1656 have been explained in paragraph [0055], so there is no need to repeat here, though the relevant figures show these common elements.

Continuing on FIG. 16B, the extracted signal 1646 from the Daisy Chain Processor 1632 goes into a Serial to Parallel converter 1640 being converted into parallel data. Then the signal goes into a Compression Decoder 1642 controlled by Compression Controller 1650, and is decompressed into uncompressed signals, then feeds into Scaler 1648 to be scaled to the requested resolution, then goes to a Splitter 1644, to be split into multiple identical signals. One of the split signals goes to a HDMI to VGA converter 1660 and is outputted from the VGA out connector 1604, the other signal goes directly to HDMI output connector 1608, and yet another signal goes to a HDMI to DP Converter 1662 and outputs from DP out connector 1610. In an embodiment where only one output is needed, item 1648, 1644, 1660, 1662, 1604 or 1608 or 1610 are optional. Optional Audio De-embedder/Mixer 1652 gets the digital audio signal from Scaler 1648, converts it to analog audio and drives the headphone via connector 1606.

XDI Node (Matrix Switcher)

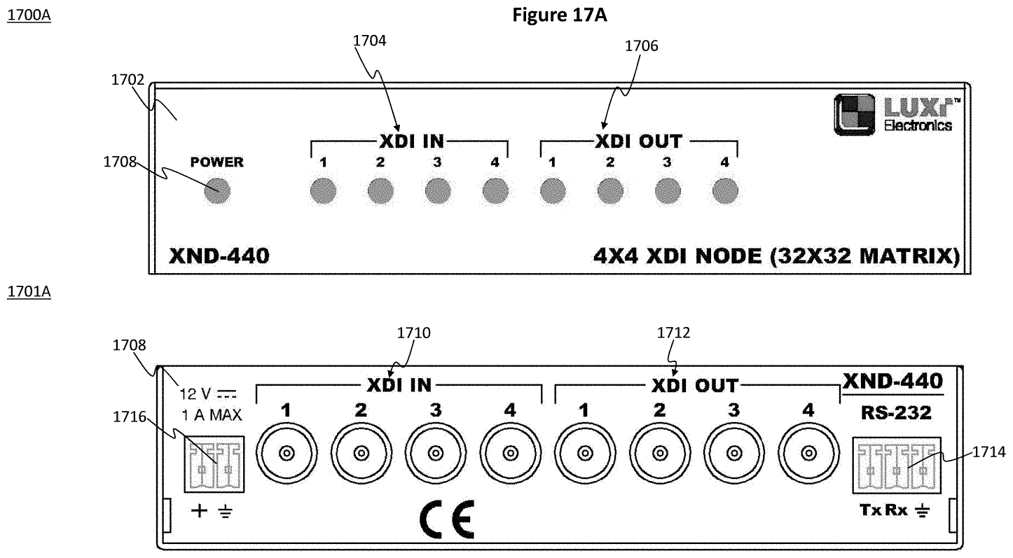

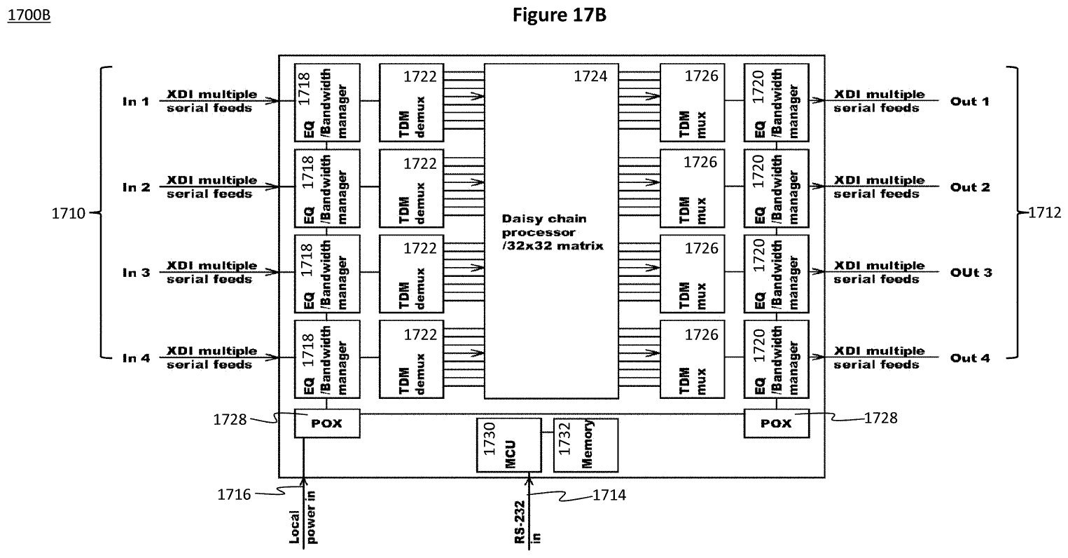

Referring now to FIG. 17A and FIG. 17B, schematically shown are XDI Compression Decoder/Splitter's front panel 1702 and its features 1700A, rear panel 1708 and its features 1701A and internal circuit block diagram 1700B, respectively. Multiple XDI coaxial cables each carry multiple sets of audio video serial data enters the device via coaxial connectors 1710 and also exits via coaxial connectors 1712. The EQ circuit 1718 on each input equalizes (amplifies) and reshapes the signals to sharp digital square waves. The Bandwidth Manager 1718 on each input works in conjunction with the Bandwidth Manager in the immediately connected device upstream to test the maximum physical link bandwidth, and also with the Bandwidth Managers in all other related devices in the system to ensure the signal data rate never exceeds the physical link's maximum bandwidth. The TDM (Time Domain Multiplexing) demux (De-Multiplexer) 1722 on each input separates the multiple sets of serial audio video data in each coaxial cable into multiple lines that each carry one set of serial audio video data, and feeds them into a Daisy Chain Processor (Matrix Switcher) 1724. The Daisy Chain Processor 1724 takes all demuxed signals from multiple TMD demux 1722s, chooses which upstream data are passed through to downstream devices via which outputs. The TMD mux (Multiplexer) 1726 for each output takes in the multiple lines that each carry one set of serial audio video data from Daisy Chain Processor 1724, and combines them into one line of multiple sets of serial audio video data for each output, and feeds it into EQ/Bandwidth Manager 1720 and sends it through a coaxial connector 1712 for each output to downstream devices. The functions of item 1716, 1728, 1714, 1730 and 1732 have been explained in paragraph [0055], and no need to repeat it here, though the relevant figures show these common elements. Please note that this is not a traditional matrix switcher because each input is not for a single set of audio video serial data from one source device, rather it is for multiple sets of audio video signals coming from a daisy chain of multiple source devices. Similarly, each output is not a single set of audio video serial data for one display, rather its multiple sets of audio video signals for multiple displays. In the example, shown in FIG. 17B, it is a 4×4 XDI node, equivalent to a 32×32 traditional matrix. Also as is common knowledge by a skilled engineer, a Switcher is a matrix switcher whose number of outputs is one; and a Splitter is a matrix switcher whose number of inputs is one. So, all the descriptions of Node (Matrix Switcher) in this paragraph also covers the multiple Switchers and Splitters embodiments.

XDI Display Devices

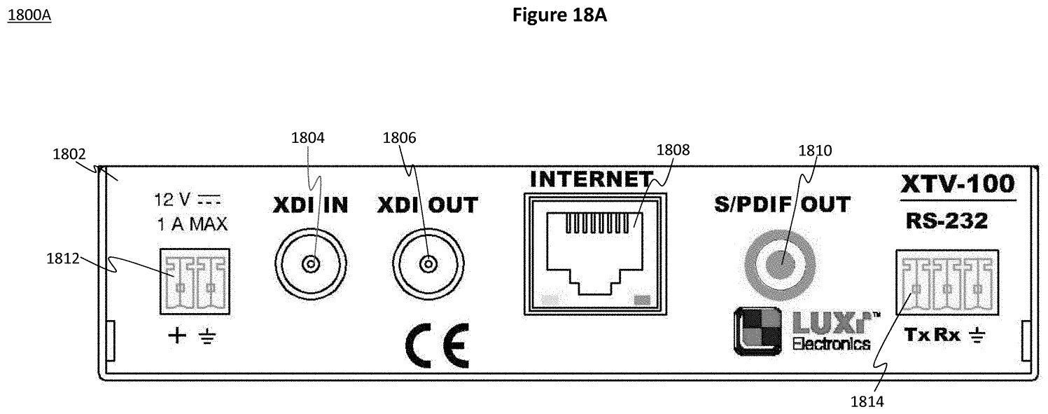

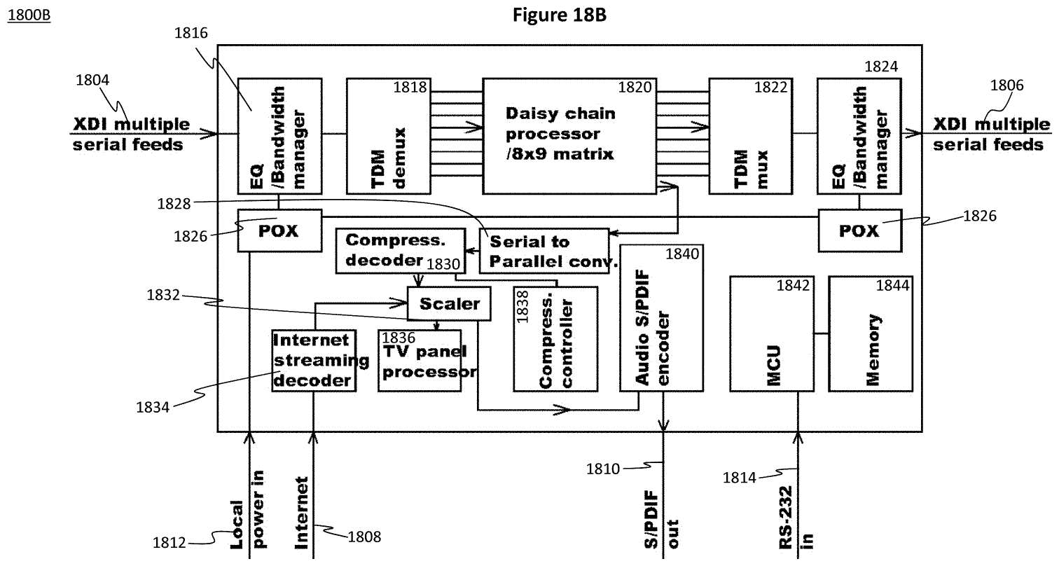

Referring now to FIG. 18A and FIG. 18B, schematically shown are XDI Display Device's I/O (Input Output) portion's rear panel 1802 and its features 1800A, and internal circuit block diagram 1800B, respectively. Once the signals converted to parallel digital signals inside a display device, the rest of the screen drive circuits or the projector panel drive circuits 1836 are part of the prior art and there is no need to explain it further here. Thus, this section only focuses on the I/O circuits that unique to the current XDI invention.

In other embodiments XDI serial video data can be sent to converted via serial to parallel converter circuitry into Frame and Pixel video and then to an XDI enhanced GPU that is configured to convert the serial Vector and Frame based video data to the Frame and Pixel based video data for display as true projected 3D video, simulated 3D video, or downgraded 2D video.

Continuing on FIG. 18A and FIG. 18 B. Item 1804, 1816, 1818, 1820, 1822, 1824, 1806, 1812, 1826, 1814, 1842 and 1844 functions the same as explained in paragraph [0077], [0078], [0079], with the only difference in 1810 and 1840, instead of a headphone analog audio output and decoder respectively, now they are S/PDIF digital audio output connector and decoder respectively. For the embodiments without XDI daisy chain feature, items 1818, 1820, 1822, 1824 and 1806 are not needed. For the embodiments without S/PDIF audio output, item 1840 and 1810 are not needed.

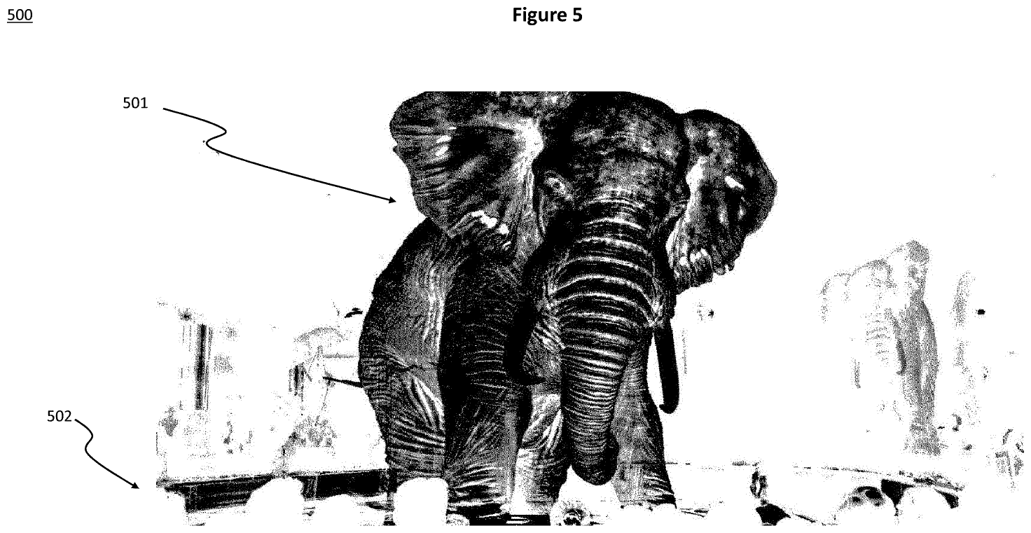

Referring now to FIG. 5; schematically shown is one embodiment 500 of how the XDI can display a 3D motion image shown in the midair 501 in front and above the viewers 502 by at least 2 video projectors outside the scene. The same XDI video data can be used in producing the 2D or 3D video signals, XDI Vector and Motion based video or converted to Frame and Pixel based video signals; 3D images in the midair or on a flat screen; requiring the viewer to wear 3D glasses or not; at any frame rates; at any pixel resolutions; because the XDI video data is XDI 3D model Vector and Motion video data that can be reproduced in any of the above variants easily. Then XDI system is highly flexible, and embodiments can be for transmission of pure XDI serial digital video signals or hybrid systems of XDI and prior art frame and pixel video signals. A skilled engineer would know how to build 3D projectors to show the 3D image in the midair from this article's disclosure plus his knowledge: https://www.popsci.com/technology/article/2011-11/3-d-projection-tech-makes-images-hover-mid-air-no-screen-necessary/

Embodiments of the internal circuitry of a 3D flat panel display includes a serial to parallel converter IC to convert the packetized 1-bit serial data received from the XDI input or internet into 32 or 64 bit or other bit depth parallel data; a GPU (graphical processing unit) to convert the 3D Vector and Motion based video data into two sets of 2D Frame and Pixel based video data; a flat panel screen processor IC to feed these 2 sets of 2D video data into two sets of pixels that overlapped close to each other on the flat panel display; the viewers to wear 3D filter glasses on their two eyes so the left eye only sees the set of image for the left eye on the flat panel screen and the right eye only sees the set of image for the right eye; then the human brain to process these two sets of images to form a 3D illusions in the mind.

Embodiments with internal circuitry of a 2D flat panel display includes a serial to parallel converter IC to convert the packetized 1-bit serial data received from the XDI input or internet into 32 or 64 bit or other bit depth parallel data; a GPU (graphical processing unit) to convert the 3D Vector and Motion based video data into one set of 2D Frame and Pixel based video data; a flat panel screen processor IC to feed this one set of 2D video data into one set of pixels to display downgraded 2D images on the flat panel display.

Embodiments of internal circuitry of a two-projector 3D display processing device includes a receiver IC to equalize the incoming data, a GPU (graphical processing unit) to convert the 3D Vector and Motion based video data into two sets of 3D video data to feed two 3D projectors located at close but different locations projecting lights into the same field of view. The circuitry of each of the two 3D projector devices includes a serial to parallel converter IC to convert the 1-bit serial data received from the input into 32 or 64 bit or other bit depth parallel data; a projector display processor IC convert this data into the data to drive the projector's image light source generators. The two lights from the two projectors are converged and crossed in the midair and form the true 3D images in the midair.

Link Bandwidth Management

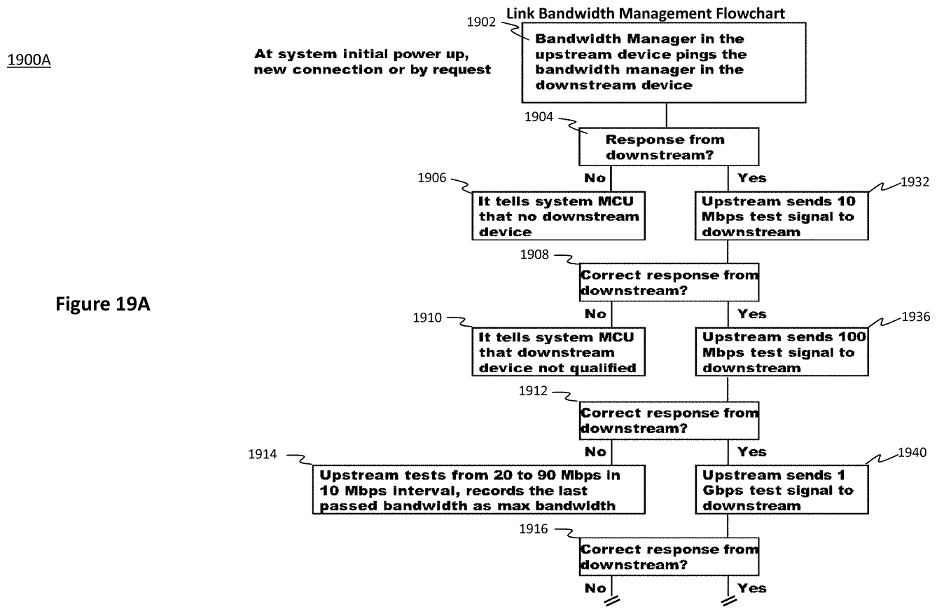

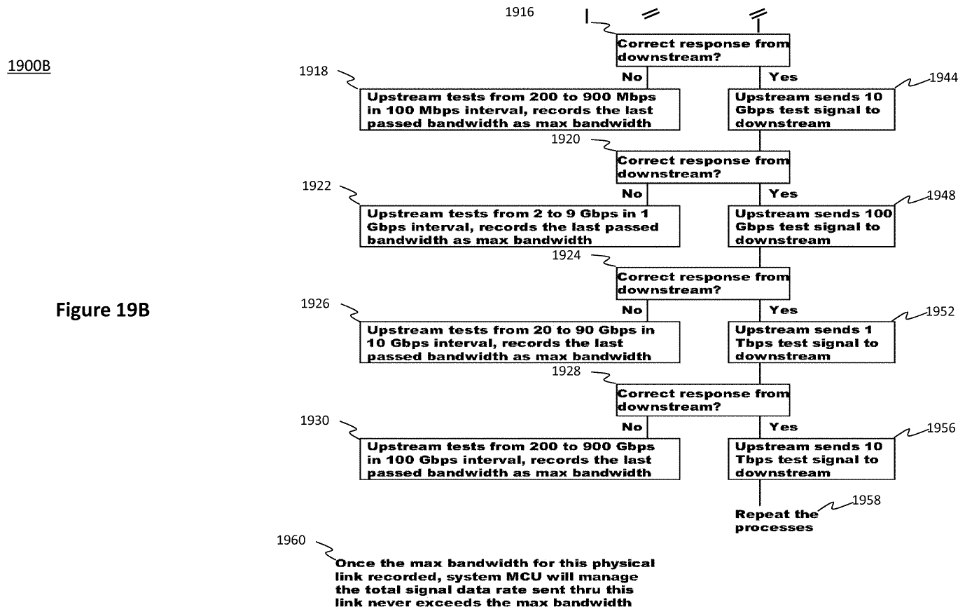

Referring now to FIG. 19 schematically shown is a representative method of Link Bandwidth Management 1900 software flowchart that is a unique feature to XDI embodiments systems. At the system initial power up, new connections or by request, Step 1902 the Bandwidth Manager in the upstream device pings the one in the downstream device. Step 1904 whether a response is received or not from downstream? Step 1906 if no response from downstream, it tells system MCU that there is no downstream device. Step 1932, if there's a response, then it sends 10 Mbps (the lowest designed bandwidth) test signal to downstream device. Step 1908 correct response from downstream is received, or not? Step 1910 if no correct response from downstream, it tells the system MCU that the downstream device is not qualified. Step 1936 if a correct response is received, it sends 100 Mbps test signal to downstream. Step 1912 correct response from downstream is received or not? Step 1914 if no, it tests from 20 to 90 Mbps in 10 Mbps interval, records the last passed bandwidth as the max bandwidth for this link. Step 1940 if yes, it now sends 1 Gbps test signal to downstream in the system. Step 1916 correct response is received from downstream or not? Step 1918 if no, it tests the 200 to 900 Mbps in 100 Mbps interval, records the last passed bandwidth as the maximum bandwidth for this link. Step 1944 if yes, it sends 10 Gbps test signal to downstream in the system. Step 1920 is the correct response from downstream or not? Step 1922 if no, it tests the 2 to 9 Gbps in 1 Gbps interval, records the last passed bandwidth as the max bandwidth for this link. Step 1948 if yes, it sends 100 Gbps test signal to downstream. Step 1924 a correct response is received from downstream or not? Step 1926 if no, it tests the 20 to 90 Gbps in 10 Gbps interval, records the last passed bandwidth as the maximum bandwidth for this link. Step 1952 yes, it sends 1 Tbps test signal to downstream. Step 1928 correct response is received from downstream or not? Step 1930 if no, it tests the 200 to 900 Gbps in 100 Gbps interval, records the last passed bandwidth as the maximum bandwidth for this link. Step 1956 yes, it sends 10 Tbps test signal to downstream in the system to repeat the process 1958. Step 1960, once the maximum bandwidth for this physical link recorded, the system's MCU will manage the total signal data rate sent through this link lever exceeding the maximum bandwidth.

Dynamic Vector and Motion Based Video Compression Flowchart

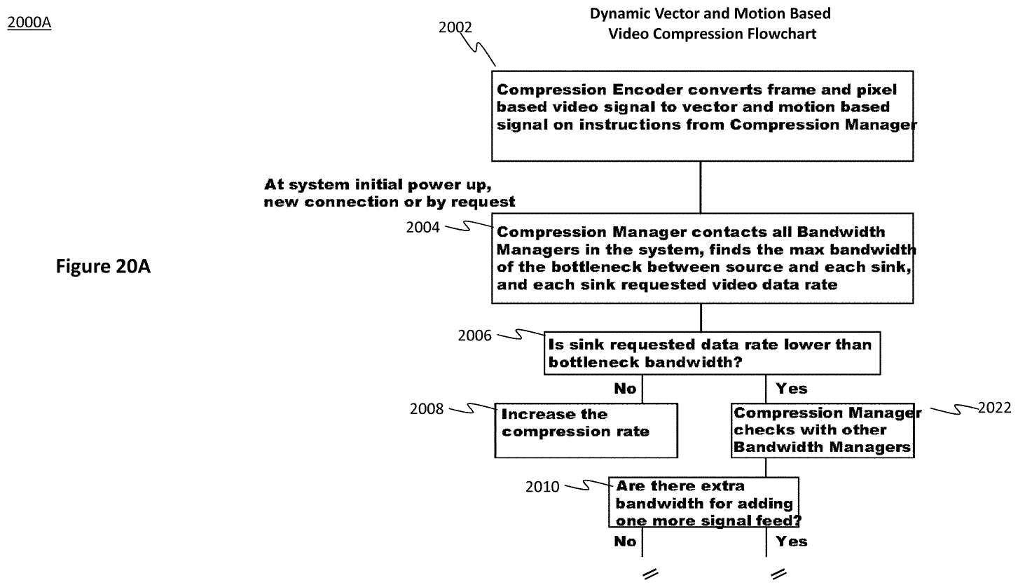

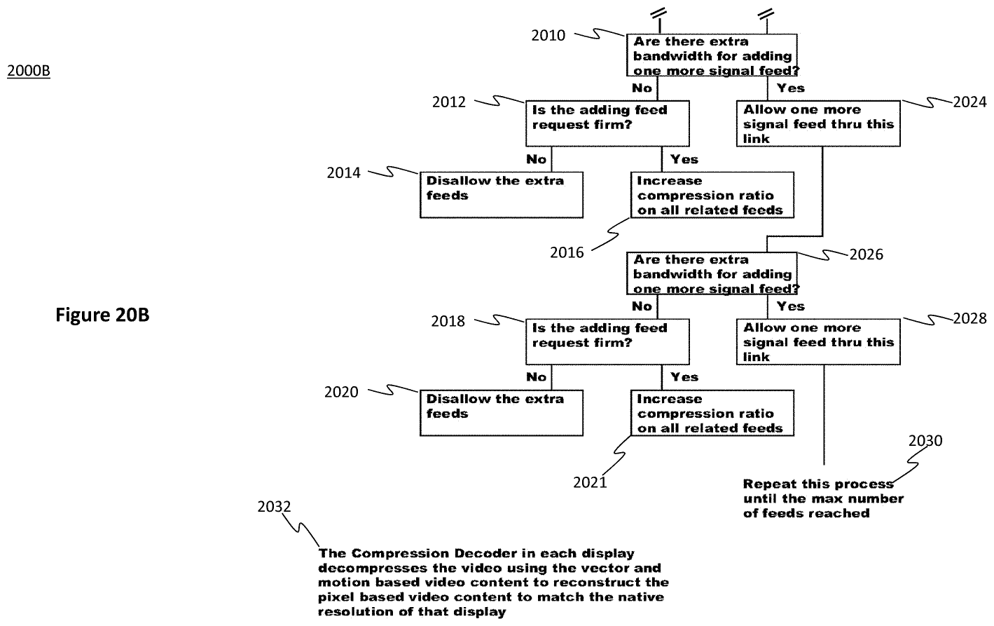

Referring now to FIG. 20 schematically shown is a representative method of Dynamic Vector and Motion Based Video Compression 2000. Step 2002 Compression Encoder recognizes the Objects from the live pixel-based video content, then uses vectors to describe the Objects in each frame (intra frame compression), and uses motion to describe the Objects' movements from frame to frame (inter frame compression) using a prior art standards like H.264 or H.265, based on the instructions from the Compression Manager on the compression ratio and format. At the system level initial power up, a new connection or by request, Step 2004 Compression Manager contacts all Bandwidth Managers in the system, finds the maximum bandwidth of the bottleneck between the source and each sink, and the requested data rate (video quality) by each display device. Step 2006 is the sink (displays) requested data rate lower than link bottleneck bandwidth or not? Step 2008 no, the Compression Manager tells the Compression Encoder to increase the compression ratio (thus reduce the video quality and signal data rate) until the signal data rate is just under the link bottleneck bandwidth. Step 2022 if yes, Compression Manager checks with other Bandwidth Managers in the system further. Step 2010 are there any extra bandwidth for adding more signal feeds or not? Step 2012 if no, is the adding feed request firm (with highest priority) or not? 2014 if no, it disallows the extra feeds. Step 2016 if yes, it increases the compression ratio (thus reducing the video quality and signal data rate) on all related feeds until they all fit to the link bandwidth. Step 2024 if extra bandwidth is available, it allows one more signal feed through this link. Step 2026 if there are extra bandwidth for adding one more signal feed or not? Step 2018 if no, is the adding extra feed request firm (with highest priority) or not? Step 2020 if no, it disallows the extra feeds. Step 2021 if yes, it increases the compression ratio (thus reducing the video quality and signal data rate) on all related feeds until they all fit to the link bandwidth. Step 2028 if extra bandwidth is available, it allows one more signal feed through this link. Step 2030 repeat this process until the maximum number of feeds is reached. Step 2023 Compression Decoder in each display device decompresses the video using the vector and motion-based video content to reconstruct the pixel-based video content to match the native resolution of that display device.

Micro Coaxial Connectors

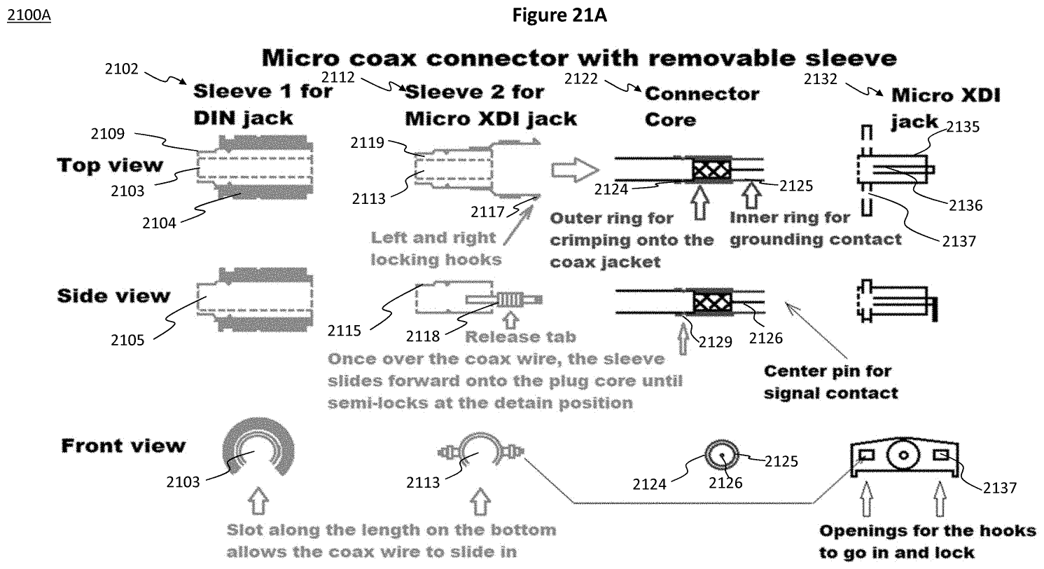

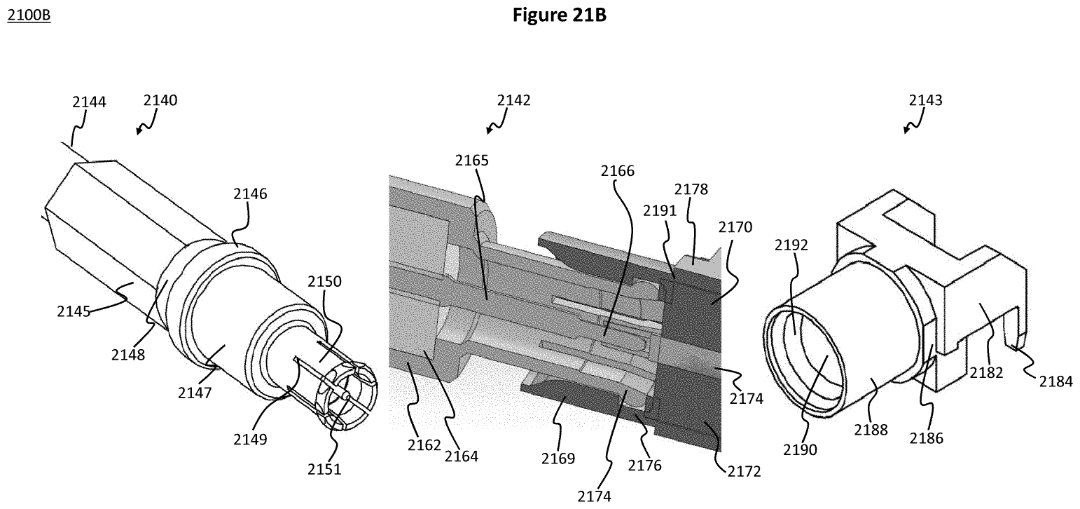

Referring now to FIG. 21A, schematically shown is an embodiment of the current invention of a micro coaxial male connector 2100 with removable sleeves and a cognate female connector. Item 2122 is the connector core for electrical contacts, which consists Center Pin 2126 from the coaxial wire for signal contact; Inner Ring 2125 inserted into the coax wire either by pushing in between the coaxial braiding and inner insulation for ground contact; Outer Ring 2124 is crimped to the coax cable jacket to create a mechanical bond, with a debossed notch ring 2129 around for semi-lock of the embossed detaining ring 2109 and 2119 described below; or by screwing in in between the coaxial braiding and inner insulation for ground contact.

Continue on FIG. 21A. Item 2102 is the current invention removable Sleeve version 1 for mating with the prior art DIN 1.0/2.3 female connectors. It has a round outer Cylinder 2104 that can lock into the DIN 1.0/2.3 female connectors; and an inter Cylinder 2105 that can slide forward onto the connector core Outer Ring 2124 with an embossed detain ring 2109 in its inner surface to be semi-locked onto the debossed notch ring 2129. A slot 2103 along the length of the Sleeve from the front to the rear ends, that allows the sleeve to slide over the coax wire before slide forward to the semi lock position when assembling the male connector; also allows the sleeve to slide back (away) from the Connector Core 2122 and slide off the coaxial wire when dissembling the male connector.

Continue on FIG. 21A. Item 2112 is the current invention removable Sleeve version 2 for mating with the current invention female micro coax connectors. It has a round cylinder 2115 that can slide onto the connector core Outer Ring 2124 with an embossed detain ring 2119 in its inner surface to be semi-locked onto the debossed notch ring 2129. The 2115 has one Locking Hook 2117 on its left side; and another Locking Hook 2117 on the right side, each with a release tab 2118 to be pushed in for unlocking. These left and right Locking Hooks goes into the matching openings 2137 on the female connector for locking. A slot 2113 along the length of the Sleeve from the front to the rear ends, that allows the sleeve to slide over the coaxial wire before slide forward to the semi lock position when assembling the male connector; also allows the sleeve to slide back (away) from the Connector Core 2122 and slide off the coax wire when dissembling the male connector.

Continue on FIG. 21A. Item 2132 is a current invention micro coaxial female connector. It has a Center Catcher 2136 for mating with Center Pin 2126 for signal contact, and a Cylinder 2135 for mating with Inner Ring 2125 for ground contact. One Opening 2137 on the left side of the Cylinder 2135, and another on the right side of 2135, for letting the two left and right Locking Hooks 2117 to slide in and hook to the outer edges. The release is achieved by pinching the left and right Release Tabs 2118 to move the Locking Hooks inward and unlock.

Referring now to FIG. 21B, schematically shown is an alternative embodiment of the current invention of a micro coaxial male connector 2100B with round locking rings and grooves. The rear flange 2145 of the male connector 2140 has similar inner ring for ground contact as the item 2125 in FIG. 21A, and is inserted into the coaxial wire 2144 by pushing and crimping or by screwing into the coax wire as described in [0071].

Continue on FIG. 21B. The male connector 2140 further consists a main body in rear 2148 and in front 2147 with a raised ring 2146 for easier hand grip.

Continue on FIG. 21B. The male connector 2140 further consists a round cylinder shaped front probe 2150 with cut gaps 2149 from the front end to near the rear end which divided the front probe into multiple separate fingers that can move independently.

Continue on FIG. 21B. The female connector 2143 consists round cylinder 2188 with the opening 2190 for accepting the male connector front probe 2150, rear connector body 2182 and ground pins 2184. The front portion of the inner side of the cylinder 2188 further consists two angled rings 2191 and 2192 at slightly different angles to guide the male connector front probe 2150 into the opening 2190.

Continue on FIG. 21B. The front edge of each finger of the male connector probe 2150 further consists a raised lip 2174; the rear end of the inner surface of the female connector cylinder 2169 further consists a debossed groove 2176. The raised lips 2174 of the front probe 2150 fingers of the male connector are pushed into the female connector cylinder 2169 until fall into the groove 2176 to create a mechanical lock. The raised lips 2174 have round edges which allows them to be pulled out of the groove 2176 with relatively strong force to release the male connector 2140 from the female connector 2143.

What is claimed is:

1. An XDI digital video acquisition, generation, transmission, and display system comprising:
at least one video source device;
each of the video source devices further comprising;
at least one circuit board comprising one or more circuitry elements and software for acquiring, generating, modeling, and processing of 3D Vector and Motion video data as descriptions of a plurality of object's shape, position and movements, or for acquiring, generating, modeling, processing, and converting parallel Frame and Pixel video data into 3D Vector and Motion descriptions of a plurality of object's shape, position and movements as 3D serial video data for transmission, wherein the 3D Vector and Motion serial based video data are generated in one of the 3 ways: 1) live video capture from real 3D objects; 2) live video converted from Frame and Pixel based video data; and 3) animated video generated by computer CPU;
a plurality of video transmission devices configured with circuitry for transmitting, receiving, switching, and converting 3D Vector and Motion based video serial data from one device to another using some or all of the following circuits and their software selected from the group consisting of an EQ (equalizer), a Bandwidth Manager, a TDM demux (time domain multiplexing demultiplexer), a daisy chain processor, a TDM mux (multiplexer), a PDX (power on XDI), a compression encoder, a compression decoder, a MCU (micro controller unit), and other transmission circuitry;
at least one display device further comprising;
at least one serial to parallel video data converter circuit that converts the 1-bit serial data to 32 or 64 bit or other bit width parallel video data for a graphic processing unit (GPU);
each of the at least one display devices further comprising one or more GPUs, wherein each of the one or more GPUs is configured with circuitry and software for receiving video data in a 3D Vector and Motion serial format and for converting it into the video data needed for one of the 3 or more ways of displaying the image;
at least one cable, wherein the at least one cable is configured for transmitting 3D serial digital video data between video capture or generation devices, transmission devices, and display devices of the system; and
software for acquiring, modeling, transmitting, and converting 3D serial digital video data from a first format to a second format or third format or more formats or combinations thereof.

2. The digital video system of claim 1, wherein the circuitry for video capture for a plurality of live or real 3D objects further comprises at least 2 Image Sensors placed offset by a distance at a first and a second angle pointing in a first and a second direction;
and at least one Video Processor using least one Software application to compare the images captured by the at least 2 Image Sensors to recognize each of the 3D object in the view, and to generate a detailed description of each object's position, size, shape, orientation, movement, surface texture or other features; an optional separate video processing device comprising at least one Video Processor.

3. The digital video system of claim 1, wherein the circuitry for video capture devices for a plurality of live or real 3D objects further comprises a LiDAR (light detection and ranging) sensor to send laser beam to scan the field of view, capture the light bounded back from the objects and convert it into video data; and at least one Video Processor using least one Software application to read the video data from the LiDAR, to use the timing from the bounced back light from each objects to recognize the distance, depth and speed of each objects, using the angle of bounce back light from each object to recognize the size, orientation texture of each objects in the view, and to generate a detailed description of each object's position, size, shape, orientation, movement, surface texture or other features; an optional separate video processing device comprising at least one Video Processor.

4. The digital video system of claim 2, wherein the 2 Image Sensors and the Video Processor further comprises hardware and software that can choose one small area of that surface and take a snapshot of it as a pixel based still picture, then send this pixel image data as surface texture data, to be used in the display device's GPU to repeat this pixel-based surface texture on all the surfaces with such material, while still reconstructing the object's 3D shape in Vector and Motion based data.

5. The digital video system of claim 1, wherein for the video converted from the prior art Frame and Pixel based video data, the circuitry further comprises a Video Processor wherein the video processor receives and stores multiple frames of data from a Frame and Pixel based video; and then compares the movement of pixels among the adjacent frames to recognize the objects in these frames, their geometrical parameters, like height, width, depth, directional facing or position, direction of movement, and speed, color, and if necessary, the Surface Texture, then writes these geometrical parameters into video data; and then feeds the video data into a Parallel to Serial converter circuit with its software to convert the 32 or 64 bit or other bit width parallel data into 1-bit serial data; and packetize the data for IP transmissions

6. The digital video system of claim 1, wherein for computer generated animation videos of claim 1, the video source device further comprises a central processing unit (CPU) IC chip and its associated surrounding circuits using 3D animation software selected from the group consisting of Microsoft PowerPoint, Autodesk Maya, Blender, SideFX Houdini, and equivalent software for generating the 2D and 3D data describing each object's position, size, shape, colors movements and other geometrical parameters.
if the video signal from any of these video source devices or components are in a parallel data format, then at least one parallel to serial converter converts the 32 or 64 bit or other bit width video data into the 1-bit serial video data;
at least one packetizing circuit and software that then converts the 1-bit serial data into packetized data fit for the IP based data transmission.

7. The digital video system of claim 1, wherein the XDI Vector and Motion based serial data can be received from the group consisting of an internet stream STB (Set Top Box), a cable TV STB, a satellite STB from remote sources, a local disk player, and a hard drive player.

8. The digital video system of claim 1, wherein the XDI Vector and Motion based serial data is switched by XDI switchers, matrix switchers or daisy chain systems or nodes, or splitters from different source devices to different sink devices.

9. The digital transmission system of claim 1, wherein the at least one device further comprises a circuit board with a Bandwidth Manager that tests the actual maximum bandwidth of each physical link in the system and gives the allowed signal data rate instructions to Compression Manager for maintaining the signal data rate never exceeding the link maximum bandwidth.

10. The digital transmission system of claim 1, wherein the at least one device further comprises a circuit board with a Compression Manager that gives instructions to a Compression Encoder on the compression ratio to be used based on the allowed signal data instructions from the Bandwidth Manager to ensure the signal data rate never exceeding the link maximum bandwidth.

11. The digital transmission system of claim 1, wherein the at least one device further comprises a circuit board with a Power over XDI circuit that sends power through the same single coaxial cable linking the devices to allow remote powering capability.

12. The digital transmission system of claim 1, further comprising:
at least one Daisy Chain Device; each daisy chain device further comprising;
a TDM (Time Domain Multiplexing) demux (De-Multiplexer) circuit that converts one link of multiple sets of audio video data from upstream device into multiple links that each contains only one set of audio video data;
a Daisy Chain Processor that is a matrix switcher circuit that chooses which upstream signals to bypass for this device to the downstream device, and which upstream signal is replaced by the local signal, and which upstream signal is extracted for local display; and
a TDM mux (Multiplexer) circuit that converts multiple links that each contains only one set of audio video data to one link of multiple sets of audio video data to downstream device.

13. The digital transmission system of claim 1, wherein the at least one Source Device further comprises:
circuitry that reads audio video data from a storage medium (e.g., disk or like device, hard drive, semiconductor memory) or from external sources like the Internet, Cable TV or Satellite TV and converts the signals to the compressed serial digital data.

14. The digital transmission system of claim 1, further comprising: a Node (Matrix Switcher) device that has a circuit board with;
one or more serial inputs that each carries at least one sets of audio video content;
one or more TDM (Time Domain Multiplexing) demux (De-Multiplexer) circuit that each converts one link of multiple sets of audio video data from upstream device into multiple links that each contains only one set of audio video data;
a matrix switcher circuit that chooses which upstream signals goes to which downstream outputs; and
one or more TOM mux (Multiplexer) circuit that each converts multiple links that each contains only one set of audio video data to one link of multiple sets of audio video data to downstream device.

15. The display GPU circuitry of claim 1, further comprising:
a serial to parallel converter circuitry and software that converts XDI's 1-bit serial data into GPU's 32 or 64-bit or other bit width parallel data; and processing and displaying images in one of the at least 3 ways:
1) wherein the GPU further comprises circuitry and software to convert the Vector and Motion based data into Frame and Pixel based data to feed the TV Panel Processor for flat screen-based 3D displays that require the viewer to ware 3D filter glasses; or
2) to downgrade the 3D video data to 2D video data for 2D image displays; or
3) wherein GPU further comprises circuitry and software to convert the one 3D Vector and Motion-based data into at least two image data for at least two projectors to form the real 3D image in the midair.

16. A method for digital data transmission system comprising:
a system-wide link Bandwidth Management protocol check in which the actual maximum bandwidth of each physical link in the system is tested and the data flow assigned to that link is maintained below the actual maximum bandwidth at all times; and
a dynamic Vector and Motion-based video content compression algorithm that only allows the requested amount of data from the sink and actual maximum bandwidth of the physical link in between whichever is lower;
the method further comprising the steps of:
sending out the test signal from the device on the upper stream of a physical data link with lowest data rate first at initial power up, handshake, or by request; waiting for the device in the other end of the physical data link to send an acknowledgement receiving an error free signal;
then increasing the test signal sent from the upper stream device with higher data rate; and repeating the step of increasing the test signal sent from the upper stream device with higher data rate, until an error message or nor response at all is received from the downstream device and then recording the signal data rate wherein receiving the error free acknowledgement from the downstream device as the actual maximum bandwidth of this physical link.

17. An interconnect system comprising:
a male connector for a cable;
the male connector further comprising a connector core for making electrical connections;
at least one removable and replaceable connector sleeve for adapting the connector to different shaped and sized connectors;
each removable and replaceable connector sleeve further comprising;
a slot opening along the side to allow the cable to slide through;
a semi locking mechanism to lock onto the connector core when sliding forward;
a locking mechanism to lock onto a cognate female connector; and
a female connector with a matching locking mechanism to the male connector;
and at least one safety break-away point.
